(19) United States
(12) Patent Application Publication
(10) Pub. No.: US 2025/0147476 A1
(43) Pub. Date: May 8, 2025

(54) Mold Lifecycle and Performance Digitalization

(71) Applicant: Kenvue Brands LLC, Summit, NJ (US)

(72) Inventors: Johnny J. Headrick, Zebulon, NC (US); David E. Jackson, Wake Forest, NC (US); Robert J. VanCoillie, Plymouth Meeting, PA (US)

(21) Appl. No.: 18/921,163

(22) Filed: Oct. 21, 2024

Related U.S. Application Data
(60) Provisional application No. 63/596,653, filed on Nov. 7, 2023.

(51) Int. Cl. G05B 13/04; B29C 37/00

(52) U.S. Cl. CPC G05B 13/042; B29C 37/00; B29C 2037/903

(57) ABSTRACT

Systems and methods for monitoring mold lifecycle and performance. The system includes a memory and a processor that receives, from a sensor implemented on a mold, first information associated with the mold, generates a digital molding process fingerprint associated with the mold based on the received first information, stores, in the memory, the generated digital molding process fingerprint, receives, from the sensor, second information associated with the mold, compares the received first information to the generated digital molding process fingerprint associated with the mold, and based on the comparison indicating a change in state of the mold, triggers a recommended action for the mold.

### CROSS-REFERENCE TO RELATED APPLICATIONS

This application claims the benefit of U.S. Provisional Application No. 63/596,653 filed Nov. 7, 2023, the contents of which is incorporated herein by reference in its entirety.

### BACKGROUND

Current molds used for molding of products, such as by injection molding and blow molding, are subject to maintenance cycles and replacement. In order to optimize the maintenance and replacement cycles, the molds are monitored so that the maintenance or replacement is performed on an optimal schedule. For example, if maintenance or replacement is performed too early, additional, unnecessary resources may be used for the maintenance or replacement, but if maintenance or replacement is performed too late, performance of the mold may have deteriorated past the optimal period leading to efficiency and/or quality control issues.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one example, a system is provided. The system includes a memory; and a processor coupled to the memory and configured to: receive, from a sensor implemented on a mold, first information associated with the mold, the received first information comprising at least one of measured plastic melt pressure, plastic melt temperature, water line temperature, blow air temperature, exhaust, or unscrewing/ejection force data; generate a digital molding process fingerprint associated with the mold based on the received first information; store, in the memory, the generated digital molding process fingerprint; receive, from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data; compare the received first information to the generated digital molding process fingerprint associated with the mold; and based on the comparison indicating a change in state of the mold, trigger a recommended action for the mold.

In another example, a computer-implemented method is provided. The computer-implemented method includes receiving, by a digital data gatherer from a sensor implemented on a mold, first information associated with the mold, the received first information comprising at least one of measured plastic melt pressure, plastic melt temperature, water line temperature, blow air temperature, exhaust, or unscrewing/ejection force data; generating, by a digital molding process fingerprint generator, a digital molding process fingerprint associated with the mold based on the received first information; storing, in a memory, the generated digital molding process fingerprint; receiving, by the digital data gatherer from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data; comparing, by a digital data analyzer, the received first information to the generated digital molding process fingerprint associated with the mold; and based on the comparison indicating a change in state of the mold, triggering, by an alert generator, a recommended action for the mold.

In another example, a computer-readable storage media is provided. The computer-readable storage media stores instructions that, when executed by a processor, cause the processor to receive, from a sensor implemented on a mold, first information associated with the mold, the received first information comprising at least one of measured plastic melt pressure, plastic melt temperature, water line temperature, blow air temperature, exhaust, or unscrewing/ejection force data; generate a digital molding process fingerprint associated with the mold based on the received first information; store, in the memory, the generated digital molding process fingerprint; receive, from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data; determine a degree of difference between the received information and the generated digital molding process fingerprint, the degree of difference indicating a state of the mold; identify at least one aspect of the received second information as contributing to the change in the state of the mold; based on the degree of difference indicating a change in the state of the mold, trigger a recommended action for the mold; and display, on a user interface device, a dashboard that presents at least one of the generated digital molding process fingerprint for the mold, the received second information associated with the mold, and the triggered recommended action for the mold.

Other technical features may be readily apparent to one skilled in the art from the following figures, descriptions, and claims.

### BRIEF DESCRIPTION OF THE DRAWINGS

The present description will be better understood from the following detailed description read in light of the accompanying drawings, wherein:

FIG. 1 illustrates an example system for monitoring mold lifecycle and performance;

FIG. 2 an example system for monitoring mold lifecycle and performance;

FIG. 3 illustrates an example injection blow molding machine including a mold that is monitored for lifecycle and performance by one or more systems described herein;

FIG. 4 illustrates an example injection blow mold that is monitored for lifecycle and performance by one or more systems described herein;

FIG. 5 illustrates an example injection mold that is monitored for lifecycle and performance by one or more systems described herein;

FIG. 6 illustrates an example injection stretch blow mold that is monitored for lifecycle and performance by one or more systems described herein;

FIG. 7 illustrates an example extrusion blow mold that is monitored for lifecycle and performance by one or more systems described herein;

FIG. 8 illustrates an example computer-implemented method of monitoring mold lifecycle;

FIG. 9 illustrates an example computer-implemented method of monitoring mold performance;

FIG. 10 illustrates an example user interface for monitoring mold performance; and

FIG. 11 is a block diagram illustrating an example computing environment suitable for implementing one or more of the various examples disclosed herein.

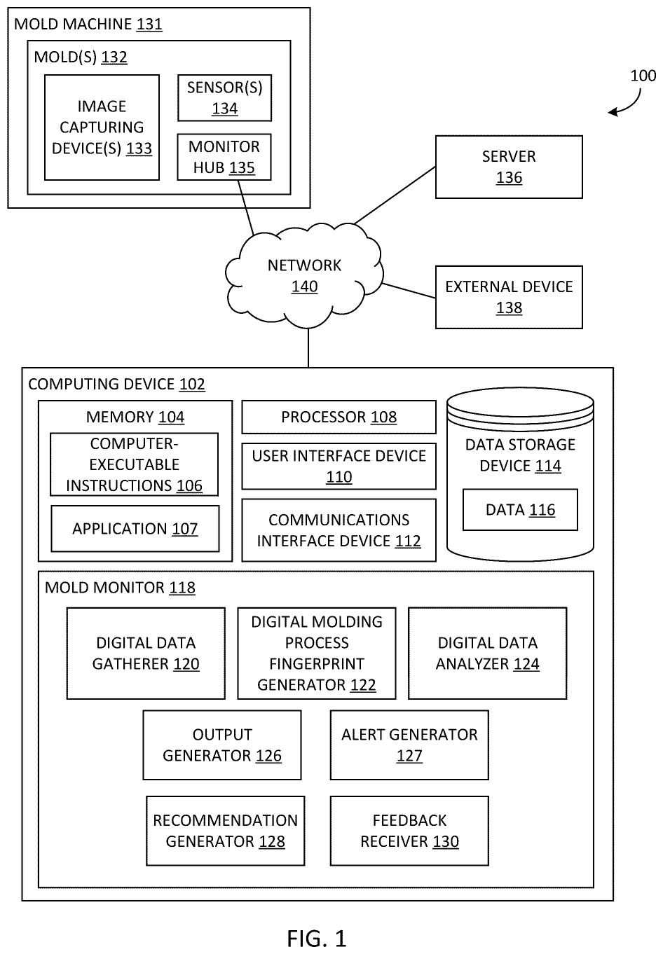

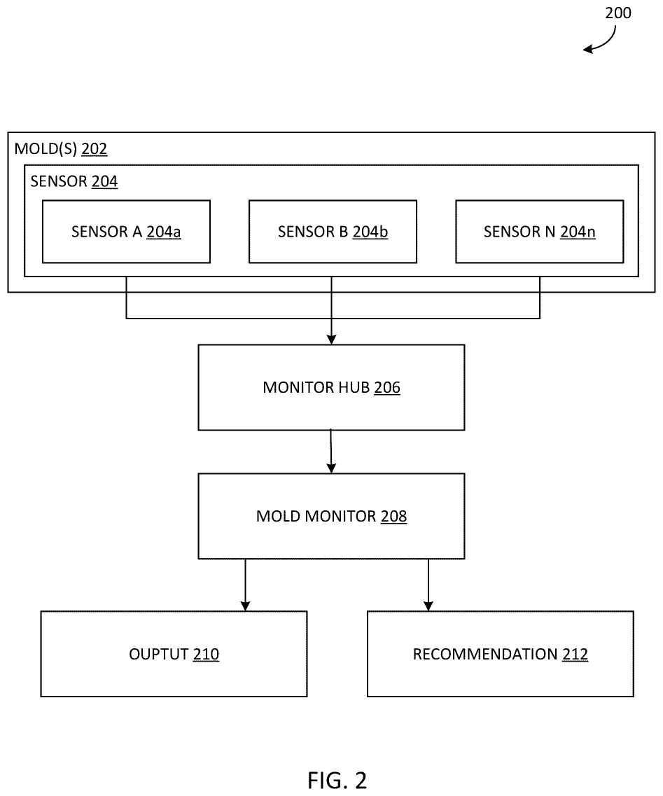

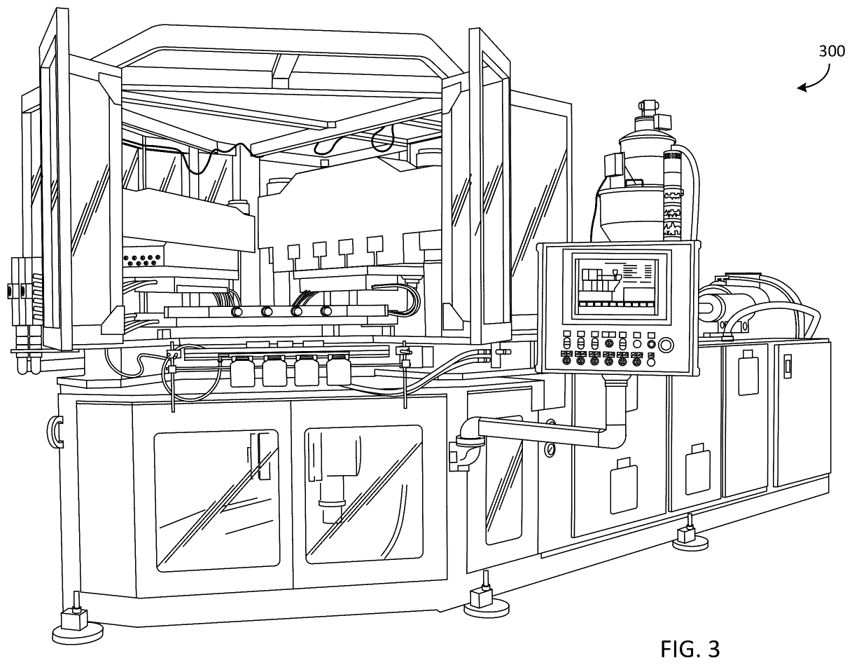

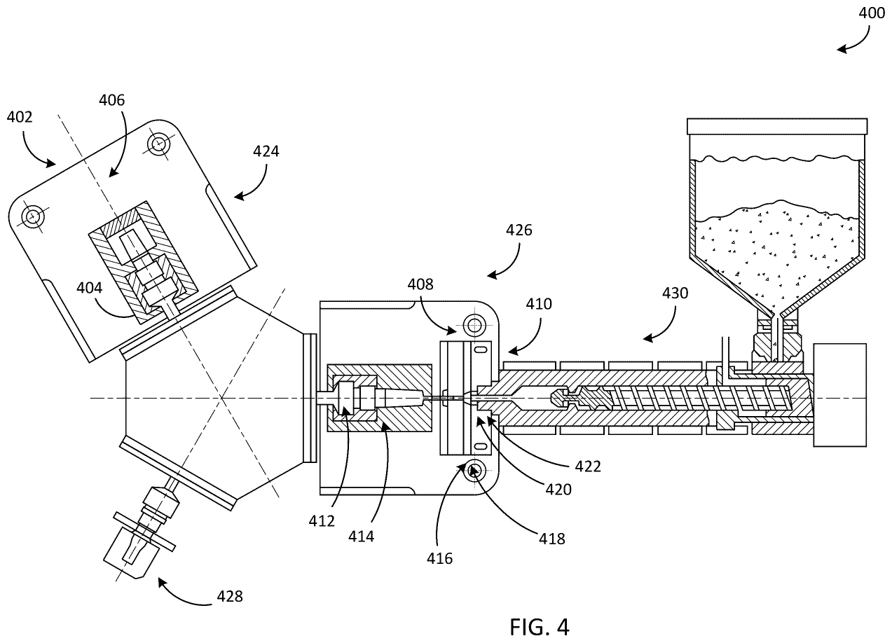

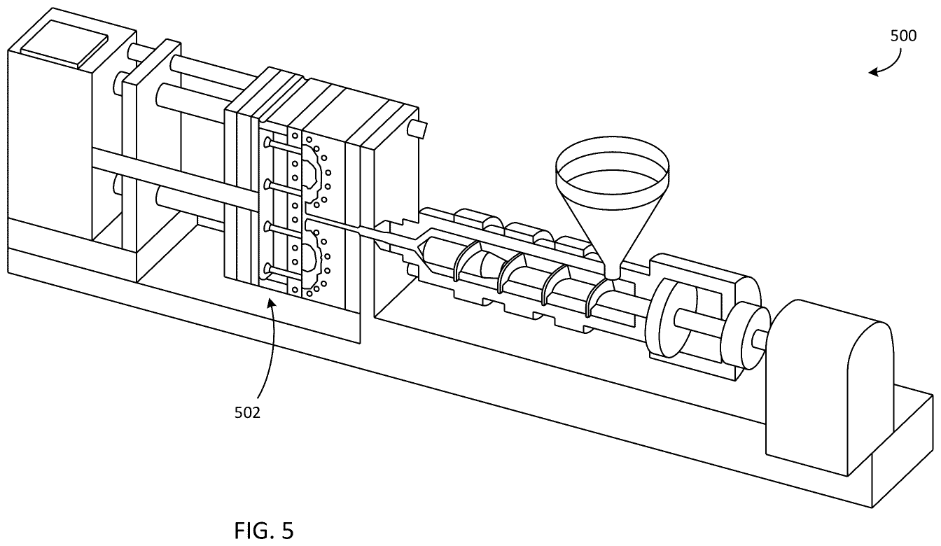

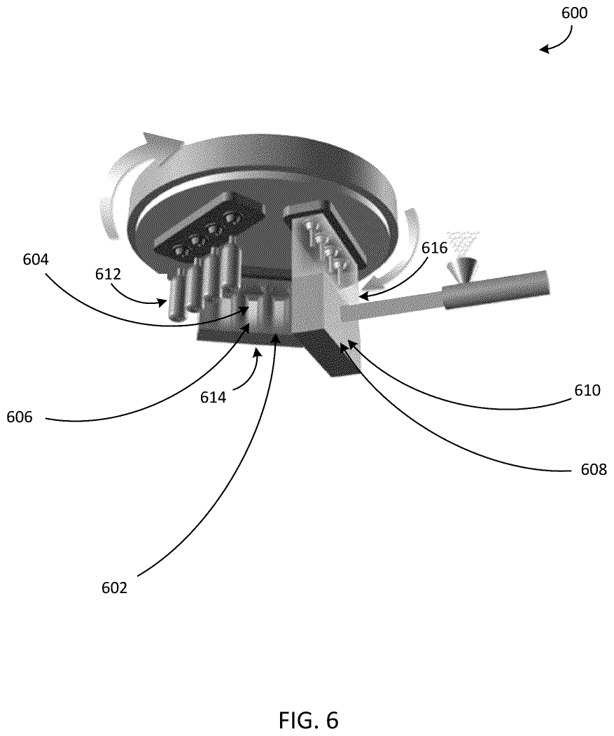

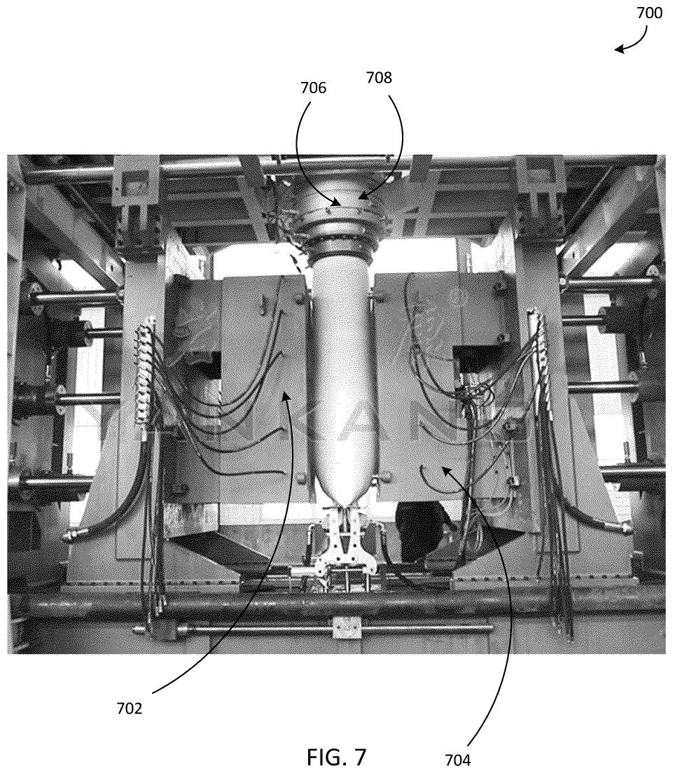

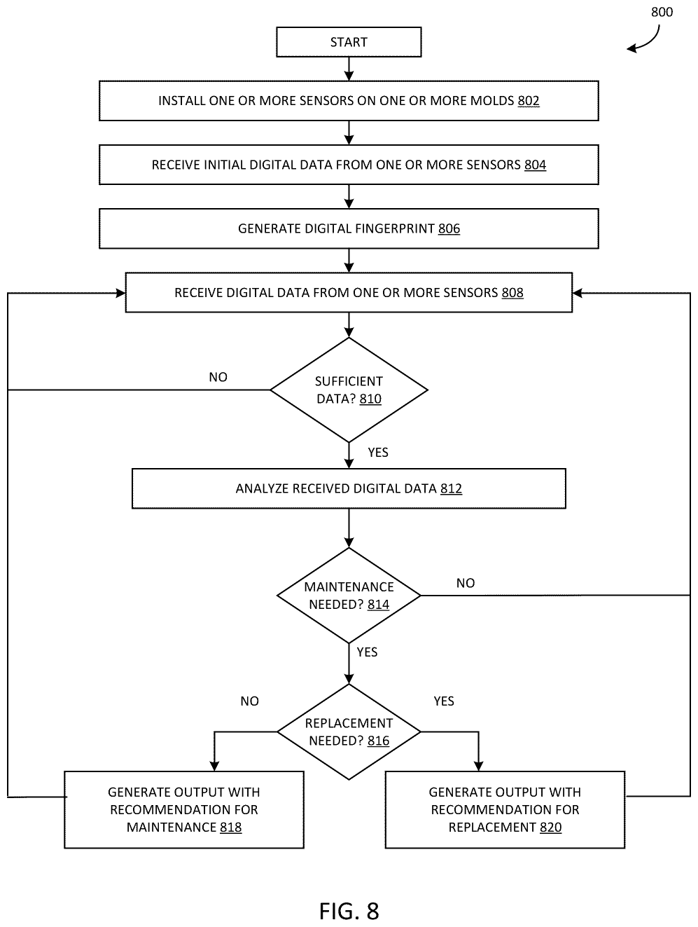

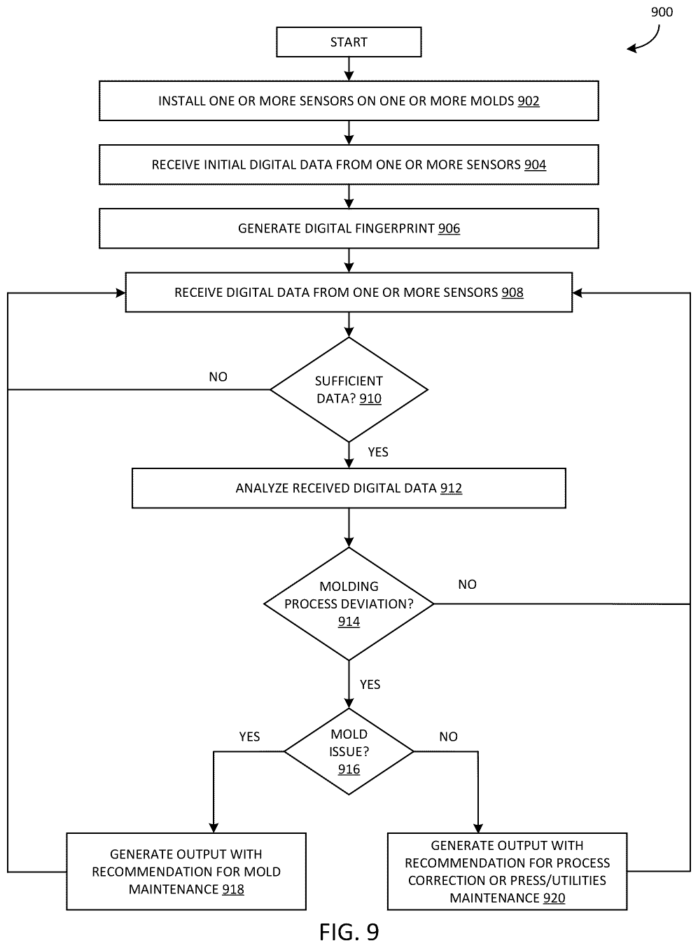

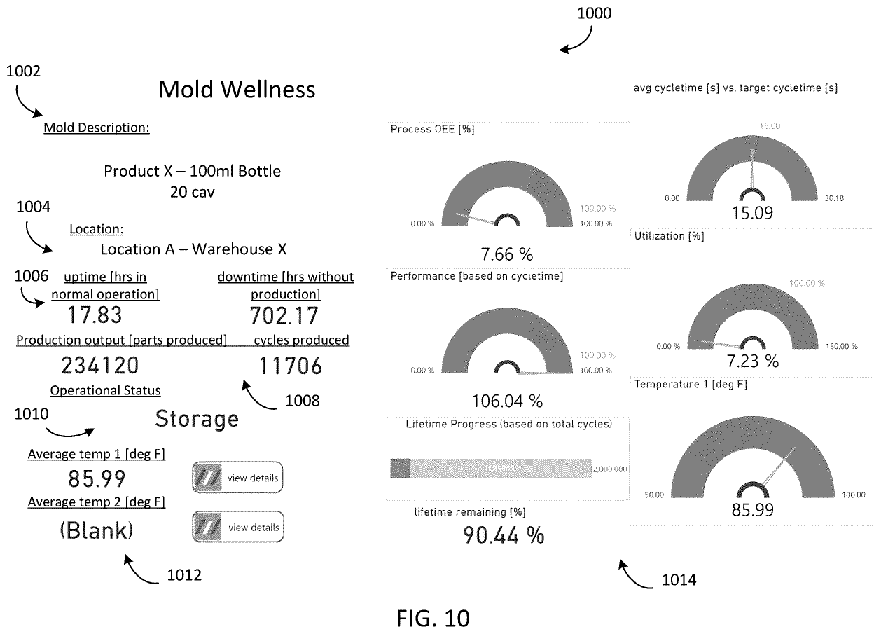

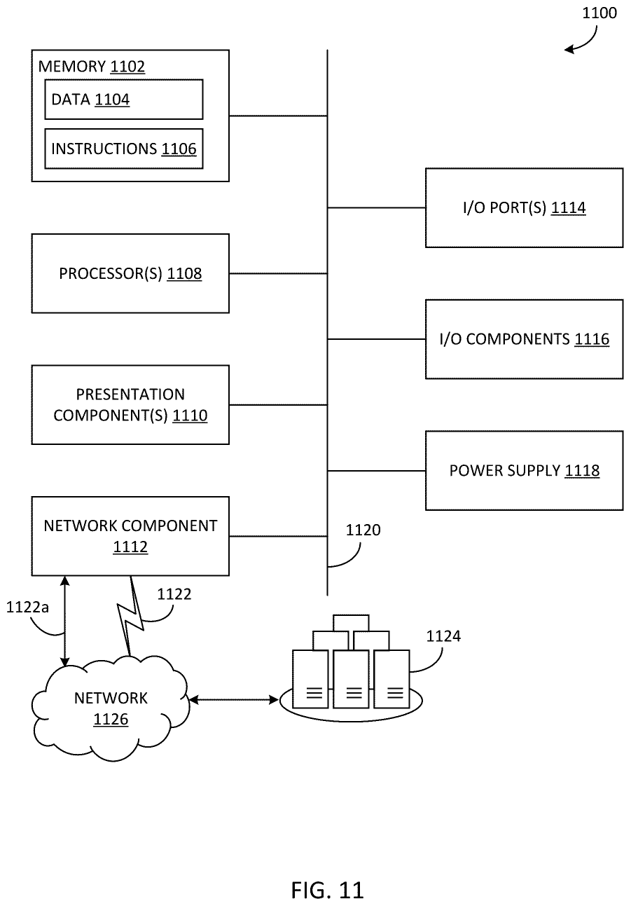

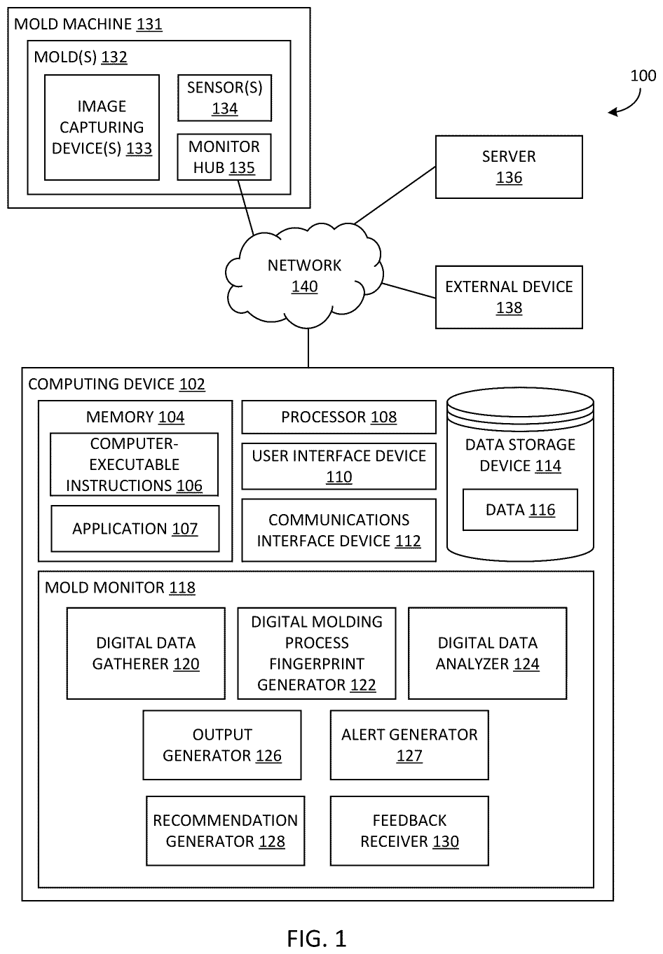

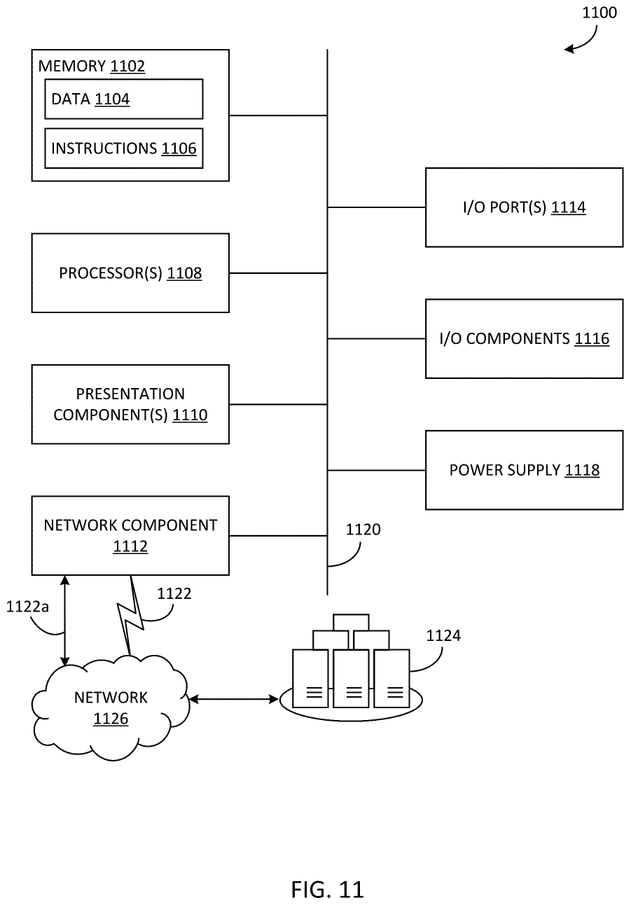

Corresponding reference characters indicate corresponding parts throughout the drawings. In FIGS. 1 to 11, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As described herein, molds are monitored for lifecycle and performance in order to determine an optimal time to perform maintenance on or replace a mold or set of molds. For example, if maintenance or replacement is performed too early, additional, unnecessary resources may be used for the maintenance or replacement, but if maintenance or replacement is performed too late, performance of the mold may have deteriorated past the optimal period leading to efficiency and/or quality control issues. Molding process and mold performance are also critically important in performing true condition-based maintenance as well as monitoring of the molding process, which is the combination of mold, molding machine (press), and molding process parameters. Many times, molding defects, out of specification results, and inadequate or premature mold maintenance are the result of poor molding process control and consistency versus the qualified state. Molding process and mold performance monitoring are critical as molding defects, out of specification results, and inaccurate mold maintenance can all be appropriately monitored and controlled through mold digitalization.

Current methods of mold monitoring are insufficient, particularly for interior aspects of the mold which are difficult to inspect at regular intervals while the mold is in regular use. These methods of mold monitoring face further challenges in environments where the quantity of molds being implemented is large, sometimes exceeding hundreds or thousands of molds in a single location. Some organizations have implemented multiple locations for molding, further straining the logistical nature of monitoring the molds. These methods typically rely on manually or digitally monitored cycle counts, i.e., each instance of a mold being utilized to create a widget, which fails to take into account a full picture of the use and/or performance of a mold or when one or more elements of a mold may have been compromised.

Current examples of the present disclosure provide systems and methods that recognize and take into account these challenges with mold lifecycle and performance monitoring. The systems and methods described herein provide mold lifecycle and performance monitoring that implements a system that provides automated digital data generation and artificial intelligence (AI) to analyze digital data received from interconnected sensors with a mold to consistently and accurately adjust predictive maintenance cycles as well as provide alerts for conditional maintenance, molding process deviation indicting poor part quality, and indicate when immediate intervention is needed. In order to achieve the monitoring, the systems and methods develop, or generate, a digital process fingerprint for each mold using a physical mold qualification and corresponding initial digital data to identify a baseline for the mold. Subsequent digital data captured throughout commercial production using the mold is compared to the generated digital molding process fingerprint to continuously monitor the mold and molding process for stability and to reduce or eliminate component quality defects for components produced using the mold.

Accordingly, examples of the present disclosure provide a technical solution to the inherently technical problem of digitally monitoring molds, particularly in relation to variables of a mold that inherently cannot be monitored while a mold is in use, such as manifold temperatures and pressures, water line temperature, blow air temperature, and so forth. The technical solution provides specialized internet of things (IoT) sensors that continuously capture specific digital data associated with a particular mold or part of a mold as well as Al that analyzes the continuously captured data, compares the data to the generated digital molding process fingerprint, determines a state of the mold based on the comparison, and generates alerts and/or recommendations for mold lifecycle and performance aspects based on a determined state of the mold. In particular, aspects of the present disclosure provide a technical solution to the inherently technical problem of data oversight and monitoring by increasing the efficiency these processes, including reducing the capacity needed to perform these processes and reducing the computing resources needed to perform these processes, due to providing focused and specific alerts in real time through a dynamic dashboard presented on a user interface and removing the need for constant, continuous manual monitoring of the data.

Aspects of the present disclosure operate in an unconventional manner by implementing a digital monitoring system that establishes a baseline, digital process fingerprint for each aspect of a particular mold and captures specific digital data associated with the established fingerprint throughout the lifecycle of the mold as it is utilized in commercial production of a component. The system further includes elements that receive and analyze the digital data to determine a state of the mold, which is used to identify when a mold is in need of maintenance and/or replacement. In addition, the system improves quality control of the components created by the commercial process by monitoring the molding process and mold performance, and ultimately allowing for the reduction or elimination of in-process and outgoing release sampling and metrology, providing the mechanism for rapid release of components to manufacturing sites, optimizing speed to market and providing mold lifecycle extension, reduced mold downtime, and lower maintenance costs yielding significant cost savings.

In some examples, the systems and methods for monitoring mold lifecycle and performance include aspects of monitoring mold performance and condition, as well as aspects of monitoring a mold process. Monitoring mold performance and condition may include the monitoring of the mold's operational status, environmental conditions, cycle count, cycle time, plastic melt temperature, plastic met pressures/flow rate, water temperatures indicating cooling performance, active cavitation, and unscrewing force. The scope of monitoring mold performance and condition includes digitally monitoring mold performance over production runs, identifying faults and unplanned downtime, using data to continuously update predictive maintenance intervals, implementing a dashboard system configured to use digital data monitor control limits and define actions for early identification of mold degradation, and generating and signaling alerts for maintenance and intervention needs. Monitoring a mold process includes monitoring cooling performance, melt temperature, melt pressure/flow rate, and active cavitation. The scope of monitoring a mold process includes digitally mapping molding process via physical mold qualification, using data to monitor process stability and production quality, and using data to identify poor practices impacting mold process.

Various examples of results of monitoring mold lifecycle and performance include detecting data changes due to intentional deviation from the qualified process, detecting process variation digitally, confirmed with bottle OOS results via metrology, and performing state of the Art mold lifecycle and performance health monitoring. This provides numerous benefits, including but not limited to automated mold lifecycle data management, reducing manual intervention, proactive conditional maintenance extending useful life of tool asset by 10-15%, reducing lifecycle costs, advanced notification of mold health issues before breakdowns, reducing business continuity risk and potential supply impact, and component rapid release opportunities at converters based on process monitoring of data.

FIG. 1 illustrates an example system for monitoring mold lifecycle and performance. The system 100 illustrated in FIG. 1 is provided for illustration only. Other examples of the system 100 can be used without departing from the scope of the present disclosure.

The system 100 includes a computing device 102, one or more mold machines 131, a server 136, an external device 138, and a network 140. The computing device 102 represents any device executing computer-executable instructions 106 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, wearable device, and/or portable media player. The computing device 102 can also include less-portable devices such as servers, desktop personal computers, kiosks, or tabletop devices. Additionally, the computing device 102 can represent a group of processing units or other computing devices.

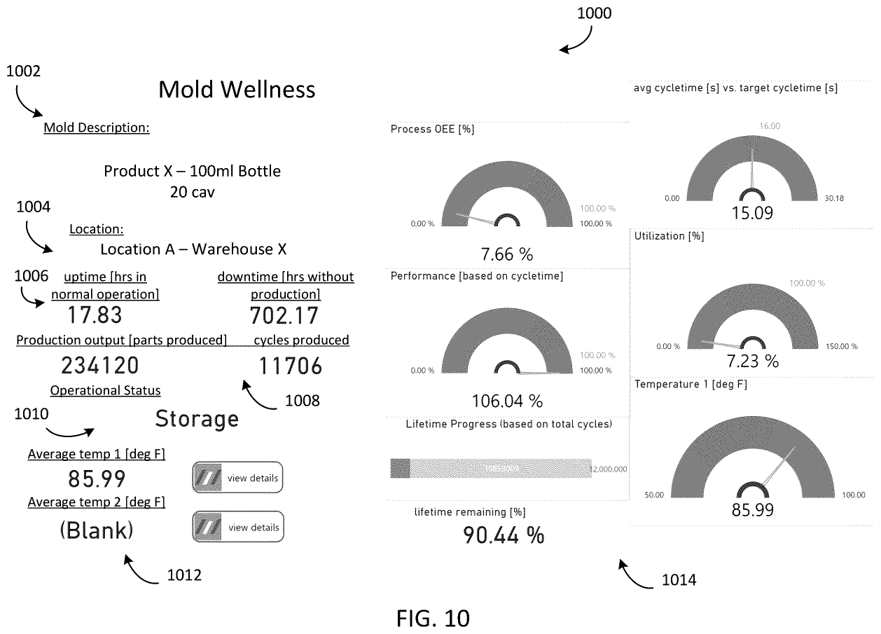

In some examples, the computing device 102 includes at least one processor 108, a memory 104 that includes the computer-executable instructions 106, and a user interface device 110. The processor 108 includes any quantity of processing units and is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIG. 10. In various examples, the processor 108 is configured to execute computer-executable instructions of the mold monitor 118 as described herein.

The memory 104 includes any quantity of media associated with or accessible by the computing device 102. In some examples, the memory 104 is internal to the computing device 102. In other examples, the memory 104 is external to the computing device 102 or both internal and external to the computing device 102. For example, the memory 104 can include both a memory component internal to the computing device 102 and a memory component external to the computing device 102, such as the server 136. The memory 104 stores data, such as one or more applications 107. The applications 107, when executed by the processor 108, operate to perform various functions on the computing device 102. The applications 107 can communicate with counterpart applications or services, such as web services accessible via the network 140. In an example, the applications 107 represent server-side services of an application executing in a cloud, such as a cloud server 136. In some examples, the application 107 is an application for assessing risk of a supplier or vendor and generating a risk assessment score for the supplier or vendor.

The user interface device 110 includes a graphics card for displaying data to a user and receiving data from the user. The user interface device 110 can also include computer-executable instructions, for example a driver, for operating the graphics card. Further, the user interface device 110 can include a display, for example a touch screen display or natural user interface, and/or computer-executable instructions, for example a driver, for operating the display. The user interface device 110 can also include one or more of the following to provide data to the user or receive data from the user: speakers, a sound card, a camera, a microphone, a vibration motor, one or more accelerometers, a BLUETOOTH® communication module, global positioning system (GPS) hardware, and a photoreceptive light sensor. In a non-limiting example, the user inputs commands or manipulates data by moving the computing device 102 in one or more ways.

The computing device 102 further includes a communications interface device 112. The communications interface device 112 includes a network interface card and/or computer-executable instructions, such as a driver, for operating the network interface card. Communication between the computing device 102 and other devices, including but not limited to sensor(s) 134 and the external device 138, may occur using any protocol or mechanism over any wired or wireless connection.

The computing device 102 further includes a data storage device 114 for storing data 116. The data 116 includes, but is not limited to, a database storing data 116 that is collected by and received from the one or more image capturing device(s) 133 and the one or more sensor(s) 134. For example, as described herein, the one or more image capturing devices 133 capture images or videos associated with a mold, or molds, 132 implemented on the mold machine 131, the one or more sensors 134 collect data associated with the mold or molds 132, such as data related to one or more of cycle counts, cycle time data, plastic melt pressure, plastic melt temperature, flow rate, active cavitation data, cooling performance data in a bank of one or more cavities of the mold 132 and/or air supply exhaust, and data associated with the force required to release molded components from the mold 132. In other examples, the data 116 includes data generated based on the analysis of images or videos received from the one or more image capturing devices 133 and the data received from the one or more sensors 134.

The data storage device 114 can include one or more different types of data storage devices, such as, for example, one or more rotating disks drives, one or more solid state drives (SSDs), and/or any other type of data storage device. The data storage device 114 in some non-limiting examples includes a redundant array of independent disks (RAID) array. In other examples, the data storage device 114 includes a database. The data storage device 114, in this example, is included within the computing device 102, attached to the computing device 102, plugged into the computing device 102, or otherwise associated with the computing device 102. In other examples, the data storage device 114 includes a remote data storage accessed by the computing device 102 via the network 140, such as the server 136 which may be a remote data storage device, a data storage in a remote data center, a cloud storage, and so forth.

The computing device 102 further includes a mold monitor 118. The mold monitor 118 is an example of a specialized processor, or processing unit, implemented on the processor 108, that performs steps of the computer-executable instructions 106 that, when executed, monitor critical aspects of the molding process and mold performance, including the lifecycle and performance of the one or more molds 132 based on analysis of the data 116 gathered from the one or more image capturing devices 133 and the one or more sensors 134. The mold monitor 118 includes a digital data gatherer 120, a digital molding process fingerprint generator 122, a digital data analyzer 124, an output generator 126, an alert generator 127, a recommendation generator 128, and a feedback receiver 130. Each of the digital data gatherer 120, digital molding process fingerprint generator 122, digital data analyzer 124, output generator 126, alert generator 127, recommendation generator 128, and feedback receiver 130 are examples of a specialized processor, or processing unit, implemented on the mold monitor 118 that performs a specialized function. As described herein, one or more components of the mold monitor 118 may implement machine-learning (ML) or artificial intelligence (AI) models to predict outcomes and generate time and condition based alerts for intervention on the mold 132 in the event that such intervention is determined to be necessary.

The digital data gatherer 120 gathers digital data, such as the data 116 collected from the one or more image capturing devices 133 and the one or more sensors 134. In some examples, the data gatherer 120 receives data from a monitor hub 135, which collects data from the one or more image capturing devices 133 and the one or more sensors 134, via the communications interface device 112. In other examples, the data gatherer 120 pulls, or extracts, data 116 from the data storage device 114 that has been previously collected from the one or more image capturing devices 133 and the one or more sensors 134 by the monitor hub 135 and transmitted to the data storage device 114 via the network 140.

The digital molding process fingerprint generator 122 generates a digital molding process fingerprint for the mold 132, or a particular aspect of the mold 132, based on initial data gathered from the one or more image capturing devices 133 and the one or more sensors 134 implemented on the mold 132. The digital molding process fingerprint, or digital process fingerprint, is an example of a baseline molding process and/or mold performance, where the data generated by the image capturing devices 133 and/or sensors 134 represents a baseline for the mold 132 at a point in which the mold 132 is operating at peak performance and efficiency, such as the beginning of a mold lifecycle or once the molding process qualification is successfully passed. In some examples, the digital molding process fingerprint includes the optimized sensor values for the mold 132 and/or optimal parameters, or tolerances, for anticipated sensor values in instances where the mold 132 is operating at the peak performance and efficiency levels.

In some examples, the digital molding process fingerprint generator 122 includes a machine learning (ML) or artificial intelligence (AI) model that receives the gathered initial digital data 116 as inputs, analyzes the gathered digital data 116 to determine whether the initially gathered initial digital data 116 is within anticipated tolerances and specifications. For examples, the ML or AI models determine anticipated baseline sensor values, i.e., anticipated digital data 116 to be gathered from a particular sensor 134 associated with a particular portion of the mold 132, based on historical sensor data, previous analysis of data gathered from similar sensors 134 associated with similar portions of similar molds 132, and so forth. In examples where the gathered initial digital data 116 is within the anticipated tolerances and specifications, the recommendation generator 128 confirms the digital molding process fingerprint for the portion of the mold 132 in accordance with the gathered initial digital data 116. In examples where the gathered initial digital data 116 is not within the anticipated tolerances and specifications, the digital data analyzer 124 triggers the alert generator 127 to send a molding process out of compliance notification, and transmits a request for updated digital data to be gathered so that the monitor hub 135 gathering the data may continue to be checked for compliance with various standards for the sensor, correct installation, and so forth.

In some examples, as digital data is captured by the image capturing devices 133 and sensors 134, over a lifecycle of the mold 132, the digital data analyzer 124 may implement one or more machine learning (ML) or artificial intelligence (AI) models to provide anticipated or estimated digital trends. For example, digital data 116 captured by a sensor may be anticipated to increase or decrease over time as the mold is utilized, indicating an anticipated decline in performance and/or efficiency of the mold 132 over a lifecycle of the mold 132. In other words, some examples of the mold 132 may have an anticipated decline in performance and/or efficiency that, while below optimal, baseline levels, are sufficient for performance of the mold 132. The lifecycle of the mold 132 includes a threshold level of performance and/or efficiency at which the mold 132 is in need of maintenance. In some examples, the lifecycle of the mold 132 includes an additional threshold level of performance and/or efficiency at which the mold 132 is in need of replacement, where the additional threshold level is a level of performance and/or efficiency lower than that of the initial threshold level at which the mold 132 is in need of maintenance. In other examples, the lifecycle of the mold 132 does not include a threshold level at which maintenance is needed and instead includes only a single threshold level at which replacement is needed.

Over time, and upon a sufficient amount of data being received to perform an analysis, the digital data analyzer 124 implements AI models to compare the captured digital data 116 to the anticipated digital data values in order to determine whether performance and/or efficiency of the mold 132 is decreasing at an expected rate, more quickly than the expected rate, or more slowly than the expected rate. In some examples, the digital data analyzer 124 continuously implements the Al models to analyze additional digital data 116 that is captured throughout the lifecycle of the mold 132. In some examples, the digital data analyzer 124 determines whether a sufficient amount of digital data has been received to perform an analysis and, upon determining a sufficient amount of digital data 116 has been received, analyzes the digital data 116 that is captured throughout the lifecycle of the mold 132. For example, digital data 116 is captured by an image capturing device 133 and/or sensor 134 during each cycle of the mold 132 and then transmitted to the computing device 102 for analysis by the digital data analyzer 124. The digital data analyzer 124 analyzes the received digital data 116 by comparing the received digital data 116 the digital molding process fingerprint generated by the digital molding process fingerprint generator 122. In some examples, digital data analyzer 124 compares the received digital data 116 to the baseline of the digital molding process fingerprint to determine whether initial performance of the mold 132 has deteriorated from the baseline level. Upon determining the initial performance of the mold 132 has deteriorated from the baseline level, the digital data analyzer 124 further compares the received digital data 116 to the threshold level, or levels, of performance and/or efficiency to determine whether the mold 132 requires maintenance and/or replacement. In some examples, the digital data analyzer 124 includes separate ML or AI models to analyze received digital data 116 from each of the image capturing devices 133 and sensors 134. In other words, for each sensor 134 and type of image capturing device 133, the digital data analyzer 124 deploys a separate ML or AI model specific to the digital data 116 captured by the particular sensor 134.

In some examples, the digital data analyzer 124 monitors operational efficiency (OEE) of each mold based on the cycle count and cycle time data received by one or more sensors associated with a particular mold. As the cycle count of a mold increases and cycle time for each cycle increases, a mold becomes less operationally efficient. OEE quantifies the change in operational efficiency of the mold over time to determine at which point the mold is ready for maintenance or refurbishment, based on a change in state of the mold from, e.g., operationally efficient to not operationally inefficient, or when the mold is ready for replacement, based on a change in state of the mold from, e.g., operationally inefficient to inoperable, or based on a total cycle count of the mold.

The output generator 126 generates an output based on results of the analysis performed by the digital data analyzer 124. In some examples, the output generator 126 generates a report including one or more of text, graphs, charts, and illustrations that depict digital data received from the one or more image capturing devices 133 and/or one or more sensors 134. In some examples, the generated report depicts the digital data relative to one or more of time, the generated digital molding process fingerprint of the mold 132, previous history of the mold 132, images and/or videos of the mold 132, and so forth. In some examples, the generated report includes data associated with a single cycle of the mold 132. In other examples, the generated report includes data associated with a plurality of cycles of the mold 132 to show changes in data over time as the mold 132 proceeds through multiple cycles.

For example, where the sensor 134 is a cooling sensor, the digital data analyzer 124 implements a cooling sensor model that generates a single data point in addition to minimum and maximum data values at regular intervals, such as every minute, every five minutes, every ten minutes, and so forth. The output generator 126 generates an output including these generated data points shown as a graph, a table, or in any other suitable manner. Where the sensor 134 is an analog RTD sensor, the digital data analyzer 124 generates a data point at regular intervals, such as every 10 ms, 20 ms, 25 ms, and so forth, and the output generator 126 generates a plot of a sinusoidal waveform. In some examples, the output generator 126 generates an output using a dynamic time warping (DTW) methodology that enables detection of similarities between specific pressure curve and an average pressure curve to quantify finished product quality risks. In some examples, the output generator 126 generates pilot digital data collected from a sensor 132 associated with a bottle mold 132. In various other examples, digital data 116 is obtained from various sensors 134, each associated with capturing data associated with separate aspects of a mold 132 or molds 134, and the output generator 126 generates a corresponding output as described herein.

In some examples, the generated output is presented on the computing device 102, such as via the user interface device 110. In some examples, the generated output is stored as an example of data 116 on the data storage device 114 or on the server 136. In some examples, the generated output is transmitted to an external device, such as the external device 138, via the communications interface device 112 for presentation on the external device 138.

The recommendation generator 128 generates a recommendation based on the generated output. In some examples, the generated recommendation is a recommendation that no maintenance or replacement is needed for the mold 132 or aspect of the mold 132, that maintenance is needed for the mold 132 or aspect of the mold 132, or that replacement is needed for the mold 132 or aspect of the mold 132. The generated recommendation is based on the analysis performed by the digital data analyzer 124 and the output generated by the output generator 126. In some examples, such as where the generated output is stored in the data storage device 114 as data 116, the generated recommendation is added to the generated output so that the output includes not only the text, graph, chart, etc. but also the generated recommendation prior to the generated output being output and presented on the user interface device 110 or the external device 138.

In some examples, the generation of the recommendation triggers an action associated with the recommendation. For example, where the recommendation is a recommendation for maintenance of the mold 132 or a process/performance aspect of the mold 132, the recommendation may trigger the alert generator 127 to generate an alert that is presented on the user interface device 110 or the external device 138, to service the mold 132. In some examples, the trigger is to automatically schedule maintenance for the mold 132, to pause cycling of the mold 132 until the mold 132 has been serviced, or any other suitable type of alert.

In some examples, the recommendation triggers the alert generator 127 to generate an alert specific to the issue identified by the specific image capturing device 133 or sensor 134 that identified a particular aspect of the mold 132 in need of service. This enables any aspect of the mold 132 that may be suspect or out of specification (OOS) performance or lifecycle aspects to have alerts generated and notifications sent out. The alerts may be set out via push notification, e-mail, text message, or any other suitable mechanism. This provides a technical solution to the inherently technical problem of data oversight and monitoring by increasing the efficiency these processes, including reducing the capacity needed to perform these processes and reducing the computing resources needed to perform these processes, due to providing focused and specific alerts and removing the need for constant, continuous manual monitoring of the data.

The feedback receiver 130 receives feedback regarding the generated recommendation. In some examples, the feedback is received via the communications interface device 112 from the external device 138, such as where the external device 138 is a device configured to receive an input from a user. In other examples, the feedback is received directly from a user via the user interface device 110. The received feedback may be received in various formats. In some examples, the feedback is binary and either confirms or rejects the recommendation. For example, where the recommendation is to perform maintenance on the mold 132, the feedback either confirms the mold 132 was in need of maintenance or rejects that the mold 132 was in need of maintenance.

In other examples, the received feedback is feedback regarding a result of the triggered action. For example, where the generated recommendation triggers maintenance of the mold 132 to be performed, the received feedback may indicate whether, following the maintenance being executed, the digital data 116 received from the sensor 134 indicates the performance and/or efficiency of the mold 132 has returned to anticipated, baseline levels as indicated by the digital molding process fingerprint. Positive feedback indicates the performance and/or efficiency of the mold 132 has returned to anticipated, baseline levels, whereas negative feedback indicates the performance and/or efficiency of the mold 132 has not returned to anticipated, baseline levels.

Each of the one or more molds 132 and the monitor hub 135 are implemented on an example of a mold machine 131. In some examples, the mold machine 131 is an injection blow mold (IBM) machine, injection stretch blow mold (ISBM) machine, extrusion blow mold (EBM) machine, or stretch blow mold (SBM) machine. Accordingly, each of the one or more molds 132 may be a blow mold, an injection mold, or any other suitable type of mold. The captured lifecycle data includes, but is not limited to, cycle time, cycle count, operational status, and geographic location. Process performance data is captured using minimally invasive embedding of sensors into molds monitoring one or more of cavity temperatures, parison neck temperatures, cooling (water) temperatures, blow air performance, plastic melt temperature, plastic melt pressure or flow rate, unscrewing force, blocked cavities, and any other values that may be deemed valuable for monitoring the performance and/or efficiency of the mold.

In general, blow molding is a manufacturing process that creates hollow plastic components by inflating a heated tube inside the mold until the tube takes the shape of the mold. Components manufactured by blow molding are typically comprised of plastic and/or glass and include bottles, containers, automotive components, toys, appliance components, and so forth. Injection molding is a manufacturing process that creates hollow components by injecting material, such as molten plastic, into a mold cavity under high pressure. Upon cooling, the injected material takes the form of the mold cavity. Components manufactured by injection molding are typically comprised of plastic and include packaging materials, containers, bottles, mechanical components, and so forth.

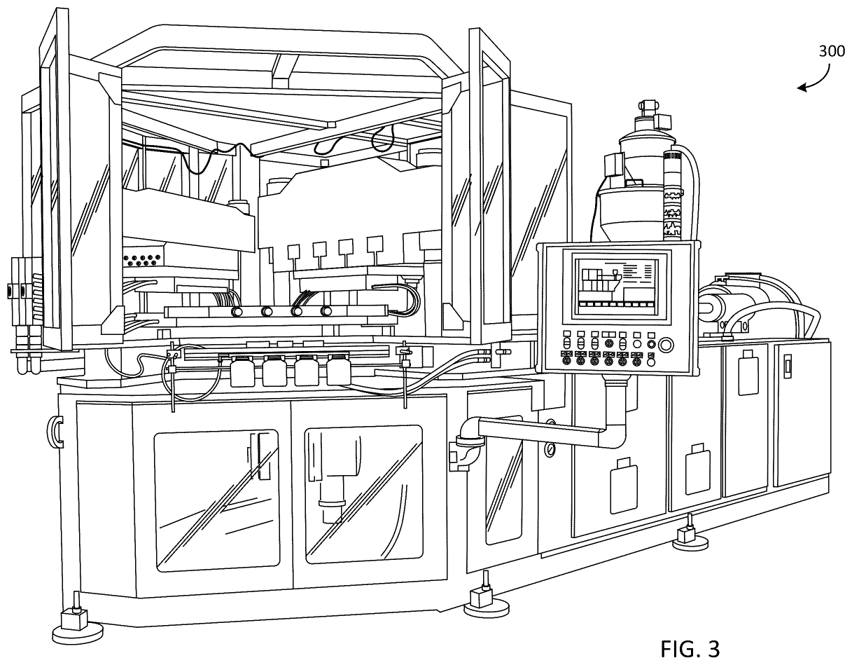

In some examples, the mold machine 131 refers to a molding machine, or press, that includes one or more molds. In these examples, the molding machine may refer to an injection blow molding machine, an injection molding machine, a blow molding machine, or any other type of molding machine that may be monitored for performance and/or efficiency. Various, non-limiting examples of molding machines are illustrated in FIGS. 3-7.

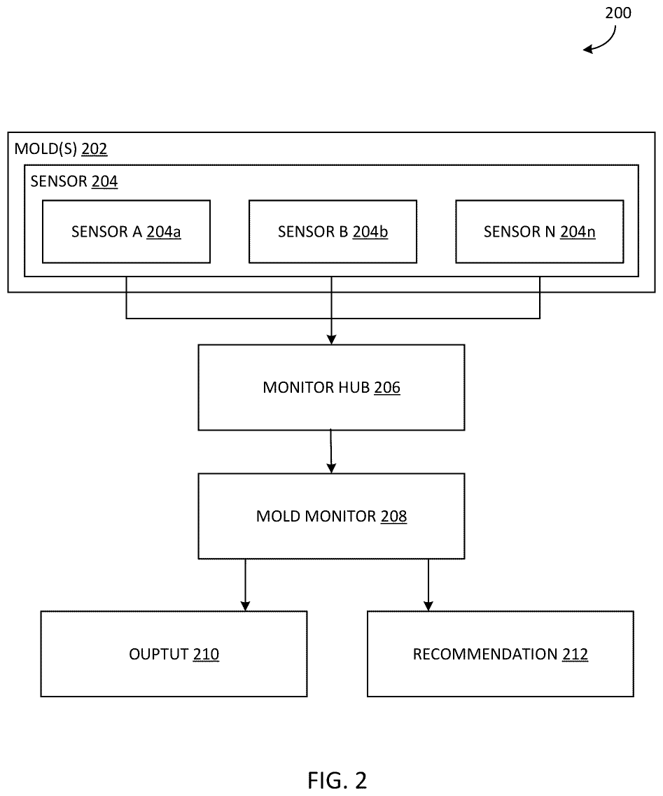

The sensors 134 are implemented, or installed, on one or more locations on the mold 132 and include various different types of sensors 134 to collect data associated with measurements of the mold 132. In some examples, each sensor 134 is one of a sensor monitor, a proximity sensor, a plastic melt pressure sensor, a plastic melt temperature sensor, a parison body temperature sensor, a parison neck/finish temperature sensor, a blow water temperature sensor, a blow air exhaust temperature sensor, an unscrewing force sensor, or any other suitable type of sensor to collect data from the mold 132. Various examples of the sensors 134 are described in greater detail below with regard to FIG. 2. The server 136, in some examples, is an example of an external storage device, remote data storage device, a data storage in a remote data center, or a cloud storage.

The external device 138 is another example of a computing device, separate from and external of the computing device 102. In some examples, the external device 138 includes a mobile computing device or any other portable device. A mobile computing device includes, for example but without limitation, a mobile telephone, laptop, tablet, computing pad, netbook, gaming device, wearable device, and/or portable media player. The external device 138 can also include less-portable devices such as servers, desktop personal computers, kiosks, or tabletop devices. Additionally, the external device 138 can represent a group of processing units or other computing devices.

In one example, the external device 138 is a mobile computing device, such as a wearable device, mobile phone, tablet, and so forth, having connectivity to the computing device 102 via the network 140. The external device 138 includes an image or video capturing device configurable to capture images and/or videos. The external device 138 may be used to capture images and/or videos of a mold that are provided to the computing device 102 in real time. The captured images and/or videos may be provided on a digital dashboard, such as the user interface 1000 illustrated in FIG. 10, implemented on the user interface device 112 or on the external device 138, and used to identify physical problems with the mold, for troubleshooting and/or resolution of the mold, and so forth. Accordingly, issues may be resolved more quickly and with the utilization of fewer resources by connecting the mold monitor 118 to the manifested issues with the mold in real time.

FIG. 2 an example system for monitoring mold lifecycle and performance. The system 200 illustrated in FIG. 2 is provided for illustration only. Other examples of the system 200 can be used without departing from the scope of the present disclosure.

The system 200 includes one or more molds 202, a monitor hub 206, and a mold monitor 208. For example, although a single mold 202 is illustrated in FIG. 2, a single mold monitor 208 may monitor more than one mold 202 or more than one iteration of the mold 202. Each mold 202 includes a plurality of sensors 204, such as a first sensor 204a, a second sensor 204b, and an nth sensor 204n. In some examples, the mold 202 is an example of the mold 132 and the sensor 204 is an example of the sensor 134. The mold 202 may be a blow mold, an injection mold, or any other suitable type of mold. Various examples of blow molds include, but are not limited to, injection blow molds (IBMs), injection stretch blow molds (ISBMs), extrusion blow molds (EBMs), and stretch blow molds (SBMs).

In some examples, each example of the sensor 204 is a different type of sensor and/or a sensor installed in a different location on the mold 202. For example, the sensor 204 may be selected from sensor monitor, a proximity sensor, a plastic melt pressure sensor, a plastic melt temperature sensor, a parison body temperature sensor, a parison neck/finish temperature sensor, a blow water temperature sensor, a blow air exhaust temperature sensor, an unscrewing force sensor, or any other suitable type of sensor to collect data from the mold 202. For example, the proximity sensor generates digital data associated with cycle count and cycle time, and can be installed on a blow side on a water manifold located on a bottom platen. The plastic melt pressure sensor generates data associated with plastic melt pressure, flow rate, and active cavitation data, and can be installed in an extruder injection nozzle and/or a parison manifold. The plastic melt temperature sensor generates data associated with plastic melt temperature, flow rate, and active cavitation data, and can be installed in an extruder injection nozzle and/or a parison manifold. The parison body temperature sensor generates data associated with cooling performance in the bank of parison cavities specific to the body area, and can be installed in the parison body water line infeed and exit. The parison neck/finish temperature sensor generating data associated with cooling performance in the bank of parison cavities specific to the neck/finish area, and can be installed in the parison neck water line infeed and exit. The blow water temperature sensor generates data associated with cooling performance in the bank of blow cavities and can be installed in the blow cavity water line infeed and exit. The blow air exhaust temperature sensor generates data associated with cooling performance of the air supply exhaust used during the blow cycle in the bank of blow cavities, and can be installed on a molding press machine air supply exhaust outfeed. The unscrewing force sensor generates data associated with the force it takes to release molded components from the mold. The unscrewing force sensor is used only in injection molding systems and can be installed in servo motor drives in the unscrewing ejection system.

In some examples, the monitor hub 206 is an example of the monitor hub 135. The monitor hub 206 gathers data from the sensors 204 and transmits the gathered date to the mold monitor 208. One or more examples of the monitor hub 206 are provided on the upper platen on the parison side of a mold machine 131 and/or the upper platen on the blow side of the mold machine 131.

The mold monitor 208 is an example of the mold monitor 118. Based on digital data 116 collected by the one or more sensors 204, the mold monitor 118 generates an output 210 and a recommendation 212. In some examples, the output 210 includes the recommendation 212. In other examples, the output 210 is separate from the recommendation 212. To generate the output 210 and/or the recommendation 212, the mold monitor 208 generates the digital molding process fingerprint of the mold 202 and/or portion of the mold 202 in which each particular sensor 204 is installed and then, upon receiving new digital data collected by each sensor 204, compares the received digital data to the digital molding process fingerprint. The output 210 includes charts, graphs, and so forth, as described herein, including changes to the digital data generated by each sensor over time. In some examples, the output 210 further includes an alert that indicates maintenance or replacement of the mold 202 or mold machine 131 on which the mold 202 is implemented is needed. The recommendation 212 includes a recommendation to perform maintenance or replace the mold 202 or aspect of the mold 202 based on the received digital data 116 from the sensor 204 indicating a need for maintenance or replacement, respectively.

FIG. 3 illustrates an example injection blow molding machine including a mold that is monitored for lifecycle and performance by one or more systems described herein. The example injection blow molding machine 300 illustrated in FIG. 3 is provided for illustration only. Other examples of the example mold 300 can be used without departing from the scope of the present disclosure.

The injection blow molding machine, or press, 300 illustrated in FIG. 3 includes one or more molds 132 that are monitored by the system 100 and/or the system 200 as described herein. The injection blow molding machine 300 illustrates an example of how one or more molds 132 are provided into a mold press. The injection blow molding machine 300 includes one or more examples of molds 132, upon which sensors 134 are installed to monitor the molds 132. The sensors 134 installed on the injection blow molding machine 300 generate digital data 116, which is sent to the mold monitor 118 where the mold 132 is monitored to determine when maintenance and/or replacement of the molds 132 within the injection blow molding machine 300, or the injection blow molding machine 300 itself, is needed.

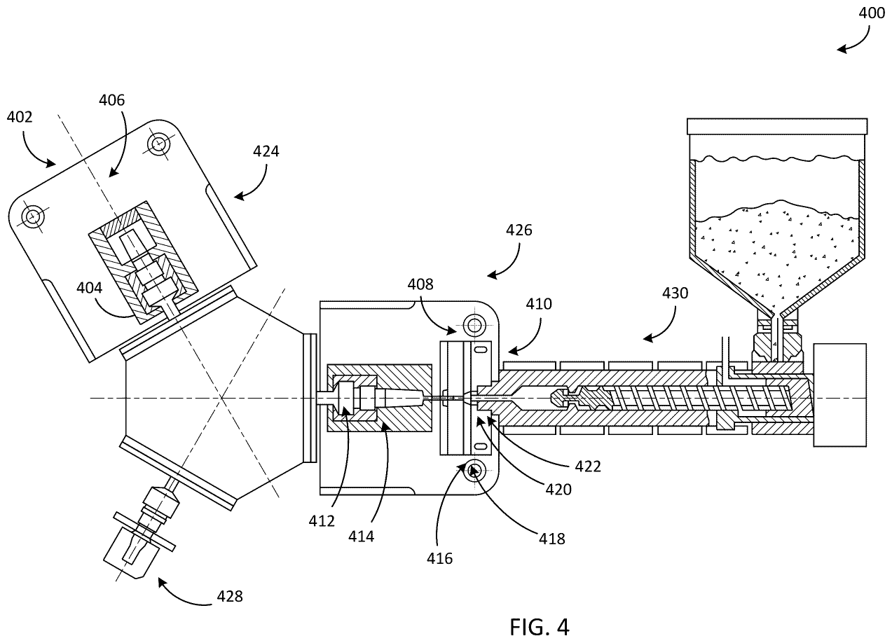

FIG. 4 illustrates an example injection blow mold that is monitored for lifecycle and performance by one or more systems described herein. The example mold 400 illustrated in FIG. 4 is provided for illustration only. Other examples of the example mold 400 can be used without departing from the scope of the present disclosure.

The example mold 400 illustrated in FIG. 4 is an example of an injection blow mold used for injection blow molding. As illustrated in FIG. 4, the example mold 400 includes a blow air exhaust temperature sensor 402, a blow water temperature sensor 404, digital monitors 406 and 408, a proximity sensor 410, a parison neck temperature sensor 412, a parison body temperature sensor 414, a manifold plastic melt temperature sensor 416, a manifold plastic melt pressure sensor 418, an injection nozzle plastic melt pressure sensor 420, and an injection nozzle plastic melt temperature sensor 422.

The blow air exhaust temperature sensor 402, blow water temperature sensor 404, and digital monitor 406 are installed on a blow mold station 424. In some examples, the digital monitor 406 is a sensor monitor that serves as a hub for the blow air exhaust temperature sensor 402 and blow water temperature sensor 404 to collect digital data 116 from the blow air exhaust temperature sensor 402 and blow water temperature sensor 404 and transmit the collected data to the mold monitor 118.

The digital monitor 408, proximity sensor 410, parison neck temperature sensor 412, parison body temperature sensor 414, manifold plastic melt temperature sensor 416, manifold plastic melt pressure sensor 418, injection nozzle plastic melt pressure sensor 420, and injection nozzle plastic melt temperature sensor 422 are installed on an injection mold station 426. The example mold 400 further includes an ejection station 428 and a preform mold station 430. In some examples, the digital monitor 408 is a sensor monitor that serves as a hub for the proximity sensor 410, parison neck temperature sensor 412, parison body temperature sensor 414, manifold plastic melt temperature sensor 416, manifold plastic melt pressure sensor 418, injection nozzle plastic melt pressure sensor 420, and injection nozzle plastic melt temperature sensor 422. The digital monitor 408 may collect digital data 116 from the proximity sensor 410, parison neck temperature sensor 412, parison body temperature sensor 414, manifold plastic melt temperature sensor 416, manifold plastic melt pressure sensor 418, injection nozzle plastic melt pressure sensor 420, and injection nozzle plastic melt temperature sensor 422 and transmit the collected data to the mold monitor 118.

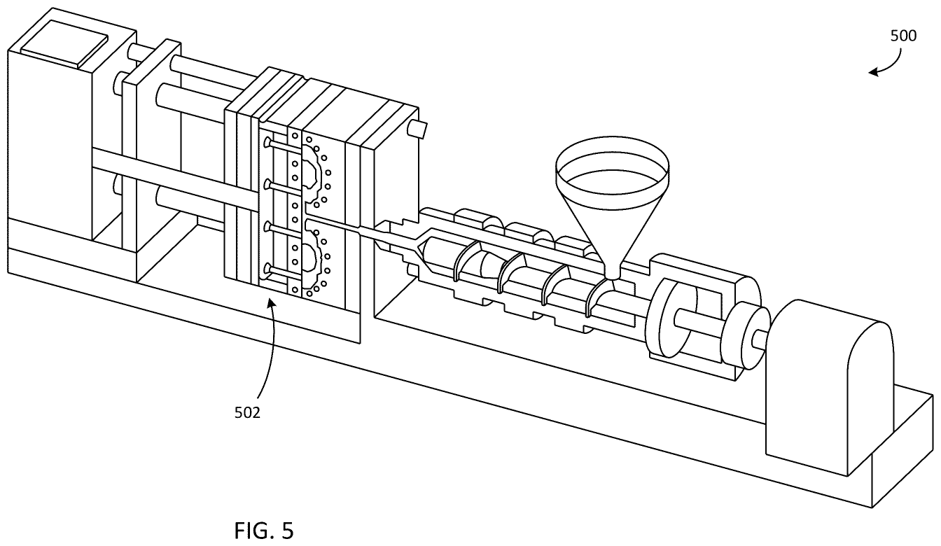

FIG. 5 illustrates an example injection blow mold that is monitored for lifecycle and performance by one or more systems described herein. The example mold 500 illustrated in FIG. 5 is provided for illustration only. Other examples of the example mold 500 can be used without departing from the scope of the present disclosure.

The example mold 500 illustrated in FIG. 5 is an example of an injection mold used for injection molding. As illustrated in FIG. 5, the example mold 500 includes unscrewing force sensors 502 installed in the injection system. In injection molding, raw plastic is placed into the hopper and funneled down into heat which turns the raw plastic into molten plastic. A reciprocating screw, turned by a screw motor drive, reciprocates and the molten plastic is injection into a mold. Upon completion of a component being created via the injection into the mold and subsequent cooling, the component is ejected out of the mold. The unscrewing force sensors 502 measure the unscrewing force, correlated with the ejection of the component from the mold.

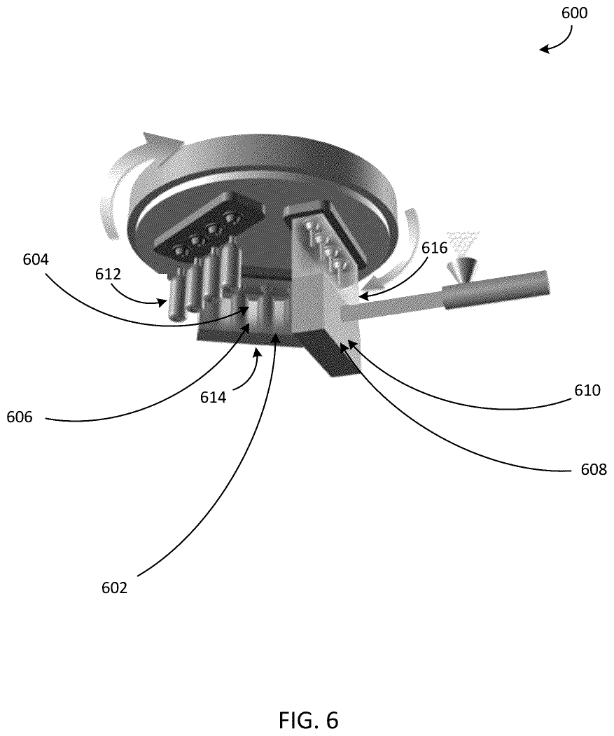

FIG. 6 illustrates an example injection stretch blow mold that is monitored for lifecycle and performance by one or more systems described herein. The example injection stretch blow mold 600 illustrated in FIG. 6 is provided for illustration only. Other examples of the example injection stretch blow mold 600 can be used without departing from the scope of the present disclosure.

The example injection stretch blow mold 600 illustrated in FIG. 6 is an example of an injection stretch blow mold used for injection stretch blow molding. As illustrated in FIG. 6, the example injection stretch blow mold 600 includes a proximity sensor 602, a temperature sensor 604 in the blow cavity, a stretch force sensor 606 in the blow station, a plastic melt temperature 608 in the manifold, and a plastic melt pressure sensor 610 in the manifold.

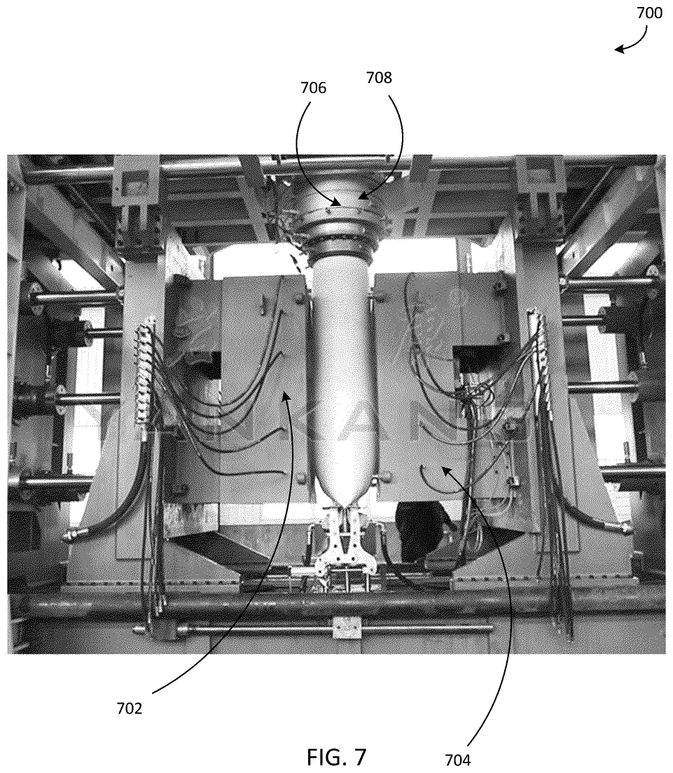

FIG. 7 illustrates an example extrusion blow mold that is monitored for lifecycle and performance by one or more systems described herein. The example extrusion blow mold 700 illustrated in FIG. 7 is provided for illustration only. Other examples of the example extrusion blow mold 700 can be used without departing from the scope of the present disclosure.

The example extrusion blow mold 700 illustrated in FIG. 7 is an example of an extrusion blow mold used for extrusion blow molding. As illustrated in FIG. 7, the example extrusion blow mold 700 includes a proximity sensor 702, a temperature sensor 704 in the blow cavity, a plastic melt temperature sensor 706 in the manifold, and a plastic melt pressure sensor 708 in the manifold.

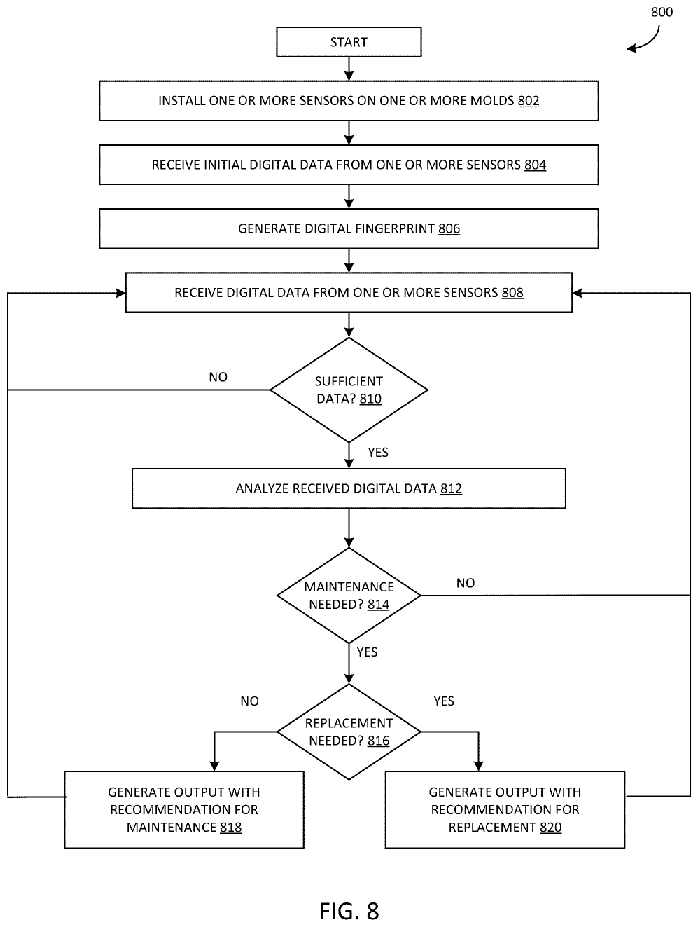

FIG. 8 illustrates an example computer-implemented method of monitoring mold lifecycle. The computer-implemented method 800 is presented for illustration only and should not be construed as limiting. Other examples of the computer-implemented method 800 can be used without departing from the scope of the present disclosure. The computer-implemented method 800 can be implemented by one or more electronic devices described herein, such as the computing device 102.

The computer-implemented method 800 begins by the one or more sensors 134 being installed on the one or more molds 132 in operation 802. In some examples, the sensors 134 are installed in different aspects, or portions, of the mold 132 to collect different types of data associated with the mold 132. The sensors 134 include one or more of the sensors illustrated on the mold 132 as shown in FIGS. 3-7.

In operation 804, the mold monitor 118 receives initial digital data 116, i.e., first information, from the one or more sensors 134. The digital data 116 may be any digital data indicating a state of, performance of, or efficiency of an aspect of the mold 132. For example, where the sensor 134 includes a proximity sensor, the digital data is associated with cycle count and cycle time. In examples where the sensor 134 includes a plastic melt pressure sensor, the digital data is associated with plastic melt pressure, flow rate, and active cavitation data. However, these examples are presented for illustration only and should not be construed as limiting. Various examples are possible. In various examples, the initial digital data 116 includes, but is not limited to, images and/or videos of the mold in operation, measured plastic melt pressure, plastic melt temperature, water line temperature, blow air temperature, exhaust, or unscrewing/ejection force data.

In operation 806, the mold monitor 118 generates a digital molding process fingerprint of the mold 132. For example, as described herein, the digital molding process fingerprint generator 122 generates a digital molding process fingerprint for the mold 132, or a particular aspect of the mold 132, based on the initial data gathered from the mold 132 in operation 804. The digital molding process fingerprint represents a baseline for the mold 132 at a point in which the mold 132 is operating at peak performance and efficiency, such as the beginning of a mold lifecycle. In some examples, the digital molding process fingerprint includes the optimized sensor values for the mold 132 and/or optimal parameters, or tolerances, for anticipated sensor values in instances where the mold 132 is operating at the peak performance and efficiency levels. The generated digital molding process fingerprint is stored, for example in the data storage device 114 as data 116 or on the server 136 as data 116.

In operation 808, the mold monitor 118 receives additional digital data, i.e., second information, from one or more of the sensors 134. In some examples, the monitor 118 receives the digital data each time digital data is collected, such as directly from each mold 134. In other examples, the mold monitor 118 receives digital data from a central sensor monitor, which is a centralized sensor hub that gathers data from other sensors 132 and transmits the collective digital data to the mold monitor 118. This example reduces the quantity of transmissions between the mold monitor 118 and the sensor(s) 134, but may result in less frequent transmissions of digital data to the mold monitor 118. In this example, the sensor monitor transmits the digital data to the mold monitor 118 at a regular interval, such as every minute, every five minutes, every ten minutes, every thirty minutes, every hour, once a day, and so forth. In various examples, the received additional digital data includes, but is not limited to, images and/or videos of the mold in operation, mold cycle count, mold cycle time, updated measured plastic melt pressure, updated plastic melt temperature, updated water line temperature, updated blow air temperature, updated exhaust, or updated unscrewing/ejection force data.

In operation 810, the digital data analyzer 124 determines whether a sufficient amount of data has been received from the sensors 134 to perform a sufficient analysis of the received digital data relative to the digital molding process fingerprint. In some examples, any amount of received digital data is sufficient to perform an analysis. In other examples, at least a threshold amount of digital data is required to perform the analysis. In some examples, the threshold amount of digital data is the same for each individual sensor 134 installed on the mold 132. In other examples, the threshold amount of digital data is different for different sensors 134 installed on the mold 132. Where the data is not determined to be sufficient, the computer-implemented method 800 returns to operation 808 and additional digital data 116 is collected.

In operation 812, upon determining there is sufficient data to analyze and compare to the digital molding process fingerprint, the digital data analyzer 124 analyzes the received digital data 116. For example, digital data 116 is captured by a sensor 134 during each cycle of the mold 132 and then transmitted to the computing device 102 for analysis by the digital data analyzer 124. The digital data analyzer 124 analyzes the received digital data 116 by comparing the received digital data 116 the digital molding process fingerprint generated by the digital molding process fingerprint generator 122. In some examples, digital data analyzer 124 compares the received digital data 116 to the baseline of the digital molding process fingerprint to determine whether initial performance of the mold 132 has deteriorated from the baseline level. Upon determining the initial performance of the mold 132 has deteriorated from the baseline level, the digital data analyzer 124 further compares the received digital data 116 to the threshold level, or levels, of performance and/or efficiency to determine whether the mold 132 requires maintenance and/or replacement. In some examples, the digital data analyzer 124 includes separate ML or AI models to analyze received digital data 116 from each of the sensors 134. In other words, for each sensor 134, the digital data analyzer 124 deploys a separate ML or AI model specific to the digital data 116 captured by the particular sensor 134.

In some examples, operation 812 includes generating, or updating a previously generated, output that includes a plot, graph, or chart of all of the received digital data. In other examples, the output is generated, or updated, as part of operation 808 as the digital data 116 is received. For example, a first threshold may represent a threshold performance or efficiency level below which maintenance is recommended, while a second threshold may represent a threshold performance or efficiency level below which replacement of the mold 132 is recommended. For example, in operation 814, the digital data analyzer 124 determines whether the values of the digital data 116 are at or above the first threshold, where the values of the digital data 116 being below the threshold indicate maintenance is recommended. Where maintenance is not determined to be needed, i.e., the values of the digital data 116 are at or above the first threshold, the computer-implemented method 800 returns to operation 808 and additional digital data 116 is collected. Where maintenance is determined to be needed, i.e., the values of the digital data 116 are below the threshold, the computer-implemented method 800 proceeds to operation 816 and determines whether the lack of performance or efficiency indicates replacement is recommended. For example, the digital data analyzer 124 compares the values of the digital data 116 to the second threshold. Where the values of the digital data 116 are at or above the second threshold, indicating the mold 132 is in a first state where replacement is not recommended, in operation 818 the output generator 126 generates an output that includes a recommendation for maintenance to be performed on the mold 132. Where the values of the digital data 116 are below the second threshold, indicating the mold 132 is in a second state where replacement is recommended, in operation 820 the output generator 126 generates an output that includes a recommendation for replacement to be performed of the mold 132. It should be understood that the first state indicates a first degree of difference between the received digital data and the initial collected data used to generate the digital molding process fingerprint, while the second state indicates a second degree of difference between the received digital data and the initial collected data used to generate the digital molding process fingerprint. Following either of operation 818 or 820, the computer-implemented method 800 returns to operation 808 and additional digital data 116 is collected.

It should be understood that the example computer-implemented method 800 illustrated in FIG. 8 is presented for example only and should not be construed as limiting. Various examples are possible. For example, the analysis of the received digital data 116 in operation 812 and subsequent comparisons of the values of the received digital data 116 to determine whether maintenance or replacement of the mold 132 is recommended may be performed in isolation based on the digital data 116 received from a single sensor 134 or in combination based on the digital data 116 received from multiple sensors 134 on a single mold 132 or mold machine. For example, if a single threshold for maintenance is not met, the generated output may not recommend maintenance, but if three thresholds from different sensors 134 are not met, the generated output may recommend the maintenance. In another example, a proximity sensor 134 may be used to monitor cycle count and cycle time data as a control for values received from other sensors 134.

Some operations illustrated in FIG. 8 may be performed or in combination. For example, operations 804 and 806 may be performed in sequence. In another example, operations 804 and 806 are performed together, where initial digital data 116 is collected and the digital molding process fingerprint is generated iteratively until the digital molding process fingerprint is completed. In one particular example, once the mold 132 is installed and warmed up, the mold monitor 118 and sensors 134 are turned on and the mold 132 is physically qualified by adjusting and setting the operating parameters to develop the qualified molding process and run the mold 132. The qualification run may last several hours, and physical molded bottle samples are pulled at specified timepoints. The physical samples are taken and dimensional measurements taken from these samples using an automated metrology apparatus/system, and the dimensional measurement results are compared to the dimensions specified in the approved commercial packaging specification. After several hours all bottle samples pulled are tested and confirmed to be in compliance and within specified tolerances of the approved commercial packaging specification. As a result, the molding process produces bottles in accordance with the approved packaging specification, resulting in the molding process being qualified and the digital molding process fingerprint being completed. The mold was then run for several hours, and different parameters of the qualified molding process were intentionally changed to confirm that these process performance changes were able to be tracked via the digital sensors and monitors. After several process parameter changes the data and graphs are observed and it is confirmed that the digital solution is able to detect and monitor molding process performance changes. Physical bottle samples may be taken during the design of experiment (DOE) test cases where process parameter changes are made and physical bottle metrology is done to confirm that the process parameter changes where digital data changes were observed, resulted in bottle dimensions that were out of specification (OOS). The results may show that the physical bottle metrology yields specific critical dimensions that were OOS. The digital tracking of molding process performance changes coupled with the physical metrology OOS results indicates that the mold digitalization solution can be used to digitally monitor mold lifecycle and molding process performance. This unlocks the ability to improve rigid plastic component speed to market by significantly reducing or eliminating physical in-process metrology and outgoing lot release metrology activities.

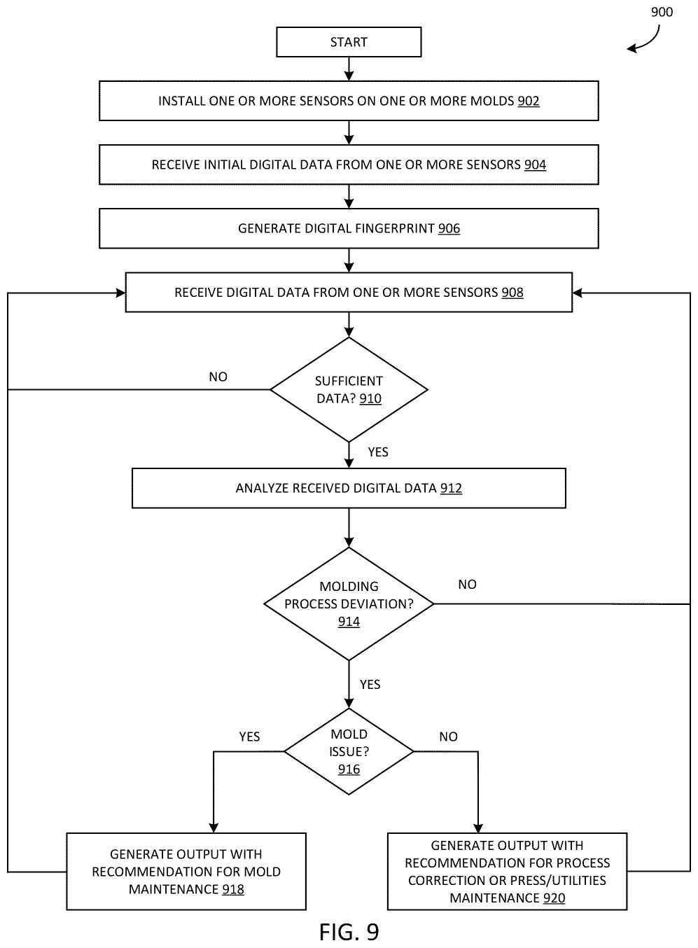

FIG. 9 illustrates an example computer-implemented method of monitoring mold performance. The computer-implemented method 900 is presented for illustration only and should not be construed as limiting. Other examples of the computer-implemented method 900 can be used without departing from the scope of the present disclosure. The computer-implemented method 900 can be implemented by one or more electronic devices described herein, such as the computing device 102. Some operations of FIG. 9 are similar or identical to operations performed in FIG. 8. For example, operations 802-812 of the computer-implemented method 800 may be the same as or similar to operations 902-912 of the computer-implemented method 900.

The computer-implemented method 900 begins by the one or more sensors 134 being installed on the one or more molds 132 in operation 902. In some examples, the sensors 134 are installed in different aspects, or portions, of the mold 132 to collect different types of data associated with the mold 132. The sensors 134 include one or more of the sensors illustrated on the mold 132 as shown in FIGS. 3-7.

In operation 904, the mold monitor 118 receives initial digital data 116, i.e., first information, from the one or more sensors 134. The digital data 116 may be any digital data indicating a state of, performance of, or efficiency of an aspect of the mold 132. For example, where the sensor 134 includes a proximity sensor, the digital data is associated with cycle count and cycle time. In examples where the sensor 134 includes a plastic melt pressure sensor, the digital data is associated with plastic melt pressure, flow rate, and active cavitation data. However, these examples are presented for illustration only and should not be construed as limiting. Various examples are possible. In various examples, the initial digital data 116 includes, but is not limited to, images and/or videos of the mold in operation, measured plastic melt pressure, plastic melt temperature, water line temperature, blow air temperature, exhaust, or unscrewing/ejection force data.

In operation 906, the mold monitor 118 generates a digital molding process fingerprint of the mold 132. For example, as described herein, the digital molding process fingerprint generator 122 generates a digital molding process fingerprint for the mold 132, or a particular aspect of the mold 132, based on the initial data gathered from the mold 132 in operation 904. The digital molding process fingerprint represents a baseline for the mold 132 at a point in which the mold 132 is operating at peak performance and efficiency, such as the beginning of a mold lifecycle. In some examples, the digital molding process fingerprint includes the optimized sensor values for the mold 132 and/or optimal parameters, or tolerances, for anticipated sensor values in instances where the mold 132 is operating at the peak performance and efficiency levels. The generated digital molding process fingerprint is stored, for example in the data storage device 114 as data 116 or on the server 136 as data 116.

In operation 908, the mold monitor 118 receives additional digital data, i.e., second information, from one or more of the sensors 134. In some examples, the monitor 118 receives the digital data each time digital data is collected, such as directly from each mold 134. In other examples, the mold monitor 118 receives digital data from a central sensor monitor, which is a centralized sensor hub that gathers data from other sensors 132 and transmits the collective digital data to the mold monitor 118. This example reduces the quantity of transmissions between the mold monitor 118 and the sensor(s) 134, but may result in less frequent transmissions of digital data to the mold monitor 118. In this example, the sensor monitor transmits the digital data to the mold monitor 118 at a regular interval, such as every minute, every five minutes, every ten minutes, every thirty minutes, every hour, once a day, and so forth. In various examples, the received additional digital data includes, but is not limited to, images and/or videos of the mold in operation, mold cycle count, mold cycle time, updated measured plastic melt pressure, updated plastic melt temperature, updated water line temperature, updated blow air temperature, updated exhaust, or updated unscrewing/ejection force data.

In operation 910, the digital data analyzer 124 determines whether a sufficient amount of data has been received from the sensors 134 to perform a sufficient analysis of the received digital data relative to the digital molding process fingerprint. In some examples, any amount of received digital data is sufficient to perform an analysis. In other examples, at least a threshold amount of digital data is required to perform the analysis. In some examples, the threshold amount of digital data is the same for each individual sensor 134 installed on the mold 132. In other examples, the threshold amount of digital data is different for different sensors 134 installed on the mold 132. Where the data is not determined to be sufficient, the computer-implemented method 900 returns to operation 908 and additional digital data 116 is collected.

In operation 912, upon determining there is sufficient data to analyze and compare to the digital molding process fingerprint, the digital data analyzer 124 analyzes the received digital data 116. For example, digital data 116 is captured by a sensor 134 during each cycle of the mold 132 and then transmitted to the computing device 102 for analysis by the digital data analyzer 124. The digital data analyzer 124 analyzes the received digital data 116 by comparing the received digital data 116 the digital molding process fingerprint generated by the digital molding process fingerprint generator 122. In some examples, digital data analyzer 124 compares the received digital data 116 to the baseline of the digital molding process fingerprint to determine whether initial performance of the mold 132 has deteriorated from the baseline level. Upon determining the initial performance of the mold 132 has deteriorated from the baseline level, the digital data analyzer 124 further compares the received digital data 116 to the threshold level, or levels, of performance and/or efficiency to determine whether the mold 132 requires maintenance and/or replacement. In some examples, the digital data analyzer 124 includes separate ML or AI models to analyze received digital data 116 from each of the sensors 134. In other words, for each sensor 134, the digital data analyzer 124 deploys a separate ML or AI model specific to the digital data 116 captured by the particular sensor 134. In some examples, operation 912 includes generating, or updating a previously generated, output that includes a plot, graph, or chart of all of the received digital data. In other examples, the output is generated, or updated, as part of operation 908 as the digital data 116 is received.

In operation 914, the digital data analyzer 124 determines whether the analyzed digital data indicates the molding process is deviating from a norm, such as the generated digital molding process fingerprint. In some examples, the analysis of whether the mold process has deviated from a norm includes the digital data analyzer 124 comparing the analyzed digital data to the generated digital molding process fingerprint. In examples where the molding process does not deviate, the computer-implemented method 900 returns to operation 908 and additional digital data 116 is collected. In examples where the molding process does deviate, the computer-implemented method 900 proceeds to operation 916 and determines whether the deviation is due to an issue with the mold 132.

Where the mold 132 is determined to be the issue resulting in the deviation, the computer-implemented method 900 proceeds to operation 918. In operation 918, the output generator 126 generates an output that includes a recommendation for maintenance to be performed on the mold 132. Where the mold 132 is not determined to be the issue resulting in the deviation, the computer-implemented method 900 proceeds to operation 920. In operation 920, the output generator 126 generates an output that includes a recommendation for a process correction and/or for press/utilities maintenance to be performed. Following either of operation 918 or 920, the computer-implemented method 900 returns to operation 908 and additional digital data 116 is collected.

Some operations illustrated in FIG. 9 may be performed or in combination. For example, operations 904 and 906 may be performed in sequence. In another example, operations 904 and 906 are performed together, where initial digital data 116 is collected and the digital molding process fingerprint is generated iteratively until the digital molding process fingerprint is completed. In one particular example, once the mold 132 is installed and warmed up, the mold monitor 118 and sensors 134 are turned on and the mold 132 is physically qualified by adjusting and setting the operating parameters to develop the qualified molding process and run the mold 132.

It should be understood that some operations of the computer-implemented methods 800 and 900 may be performed in sequence or in combination. In one particular example, following the analysis of the digital data, a determination of whether the molding process has deviated from the digital molding process fingerprint is performed in operation 914, which may be used to determine whether maintenance is needed in operation 814. In another example, the received digital data is analyzed in operation 812 or 912 and subsequent operations 814-820 and 914-920 are concurrently performed.

FIG. 10 illustrates an example user interface for monitoring mold performance. The example user interface 1000 illustrated in FIG. 10 is provided for illustration only. Other examples of the user interface 1000 may be used without departing from the scope of the present disclosure.

The user interface 1000 is provided as a digital dashboard that includes at least one of the generated digital molding process fingerprint for the mold, the data that is collected and received from one or more sensors associated with the mold, alerts, and the triggered recommended action for the mold. In some examples, the user interface 1000, or user interface device, is implemented on the user interface device 110 of the computing device 102. In some examples, the user interface 1000 is implemented on the external device 138.

The user interface 1000 includes mold description 1002. The mold description 1002 identifies the mold for which the respective information is provided, the sensor on a particular mold for which the respective information is provided, or both. For example, the mold description 1002 illustrated in FIG. 10 identifies the mold as a mold for the packaging of Product X, which is a bottle of 100 ml size, and twenty cavities to generate the package. The user interface 1000 further identifies a location 1004 of the mold identified in the mold description 1002. For example, the location 1004 identifies the location as Location A in Warehouse X.

The user interface 1000 further includes various examples of raw data, including time-based data 1006, runtime and output production data 1008, operational status 1010, and temperature data 1012. The time-based data 1006 includes runtime and uptime, which is the number of hours the identified mold is used in normal operation, and downtime, which is the number of hours the identified mold is without production. The production data 1008 includes production output, the number of parts produced by the identified mold, and cycles produced, the number of cycles used to produce the produced parts. As shown in FIG. 10, the parts produced is equal to the cycles produced of a full mold. For example, the mold description 1002 identifies the mold as having twenty cavities, so 11,706 cycles of twenty full cavities yields 234,120 parts produced. The operation status 1010 identifies the identified mold as in storage, currently operating, currently down, and so forth. The temperature data 1012 includes an average temperature 1 and average temperature 2 in degrees Fahrenheit of the water moving through the mold cooling channels, which can be used to track molding process changes and/or blocked cavities based on water temperature fluctuation.

The user interface 1000 further includes various examples of visualization data 1014. Various examples of the visualized data shown as examples of visualization data 1014 includes a process OEE percentage, a performance percentage, lifetime progress based on total progress, lifetime remaining, average versus target cycle time, utilization percentage, temperature, and so forth. In some examples, one or more examples of the visualization data 1014 visualize examples of the raw data also presented on the user interface 1000. The visualization data 1014 may include one or more of rings, tables, charts, bar graphs, line graphs, or any other suitable form of visual representation that indicates the performance of the mold.

In some examples, the user interface 1000 is dynamic. For example, the user interface 1000 may automatically provide the most recent data received from a sensor associated with a mold or data that is deemed to be most relevant, such as data that is outside the normal range of the mold indicating a potentially changed state of the mold. In other examples, the user interface 1000 provides a triggered alert and recommendation for the mold. For example, the user interface 1000 may present the generated digital molding process fingerprint for the mold as well as, based on a state of the mold being determined to have been changed by the digital data analyzer 124, received data from the sensor and a time-and condition-based alert for intervention of the mold that includes the recommended action that is triggered for the mold based on the received sensor data. For example, the user interface 1000 may present a recommended action of a maintenance action of the mold where the degree of difference between the digital molding process fingerprint of the mold and the received data indicates a first degree of difference, and may present a recommended action of re-executing molding process development, mold maintenance, or replacement of the mold where the degree of difference between the digital molding process fingerprint of the mold and the received data indicates a second degree of difference that is greater than the first degree of difference.

In some examples, the user interface 1000 includes multiple different view pages. For example, the user interface device 110 may present a first page, referred to as a summary page, that includes a summary of each mold being monitored by the mold monitor 118. The summary page identifies any and all molds running with selectable, active alerts requiring some intervention. When an alert for a particular mold is selected, the details of the particular mold, such as those shown in FIG. 10, are provided on the user interface 1000. Accordingly, the user interface 1000 provides an improved user interface enabling improved human-computer interaction by reducing the burden of user inputs to the computing device 102. In particular, the presentation of a first summary page providing each active alert requiring some intervention that, when selected by an input, navigates directly to the mold associated with the active alert with a generated recommendation for performing the intervention to resolve the issue, is an improved user interface that enables improved human-computer interaction.

### Example Operating Environment

FIG. 10 is a block diagram of an example computing device 1100 for implementing aspects disclosed herein and is designated generally as computing device 1100. Computing device 1100 is an example of a suitable computing environment and is not intended to suggest any limitation as to the scope of use or functionality of the examples disclosed herein. Neither should computing device 1100 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1100 includes a bus 1120 that directly or indirectly couples the following devices: computer-storage memory 1102, one or more processors 1108, one or more presentation components 1110, I/O ports 1114, I/O components 1116, a power supply 1118, and a network component 1112. While computing device 1100 is depicted as a seemingly single device, multiple computing devices 1100 may work together and share the depicted device resources. For example, memory 1102 may be distributed across multiple devices, and processor(s) 1108 may be housed with different devices.

Bus 1120 represents what may be one or more busses (such as an address bus, data bus, or a combination thereof). Although the various blocks of FIG. 10 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 10 and the references herein to a “computing device.” Memory 1102 may take the form of the computer-storage media references below and operatively provide storage of computer-readable instructions, data structures, program modules and other data for computing device 1100. In some examples, memory 1102 stores one or more of an operating system, a universal application platform, or other program modules and program data. Memory 1102 is thus able to store and access data 1104 and instructions 1106 that are executable by processor 1108 and configured to carry out the various operations disclosed herein.

In some examples, memory 1102 includes computer-storage media in the form of volatile and/or nonvolatile memory, removable or non-removable memory, data disks in virtual environments, or a combination thereof. Memory 1102 may include any quantity of memory associated with or accessible by computing device 1100. Memory 1102 may be internal to computing device 1100 (as shown in FIG. 10), external to computing device 1100, or both. Examples of memory 1102 include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 1100. Additionally, or alternatively, memory 1102 may be distributed across multiple computing devices 1100, for example, in a virtualized environment in which instruction processing is carried out on multiple computing devices 1100. For the purposes of this disclosure, “computer storage media,” “computer-storage memory,” “memory,” and “memory devices” are synonymous terms for computer-storage memory 1102, and none of these terms include carrier waves or propagating signaling.

Processor(s) 1108 may include any quantity of processing units that read data from various entities, such as memory 1102 or I/O components 1116 and may include CPUs and/or GPUs. Specifically, processor(s) 1108 are programmed to execute computer-executable instructions for implementing aspects of the disclosure. The instructions may be performed by the processor, by multiple processors within computing device 1100, or by a processor external to client computing device 1100. In some examples, processor(s) 1108 are programmed to execute instructions such as those illustrated in the in the accompanying drawings. Moreover, in some examples, processor(s) 1108 represent an implementation of analog techniques to perform the operations described herein. For example, the operations may be performed by an analog client computing device 1100 and/or a digital client computing device 1100. Presentation component(s) 1110 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1100, across a wired connection, or in other ways. I/O ports 1114 allow computing device 1100 to be logically coupled to other devices including I/O components 1116, some of which may be built in. Example I/O components 1116 include, for example but without limitation, a microphone, joystick, game pad, satellite dish, scanner, printer, wireless device, etc.

Computing device 1100 may operate in a networked environment via network component 1112 using logical connections to one or more remote computers. In some examples, network component 1112 includes a network interface card and/or computer-executable instructions (e.g., a driver) for operating the network interface card. Communication between computing device 1100 and other devices may occur using any protocol or mechanism over any wired or wireless connection. In some examples, network component 1112 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1112 communicates over wireless communication link 1122 and/or a wired communication link 1122a to a cloud resource 1124 across network 1126. Various different examples of communication links 1122 and 1122a include a wireless connection, a wired connection, and/or a dedicated link, and in some examples, at least a portion is routed through the internet.

Although described in connection with an example computing device 1100, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and are non-transitory, i.e., exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

In some examples, a system includes a memory; and a processor coupled to the memory and configured to: receive, from a sensor implemented on a mold, first information associated with the mold, the received first information comprising at least one of measured plastic melt pressure, plastic melt temperature, water line temperature, blow air temperature, exhaust, or unscrewing/ejection force data; generate a digital molding process fingerprint associated with the mold based on the received first information; store, in the memory, the generated digital molding process fingerprint; receive, from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data; compare the received first information to the generated digital molding process fingerprint associated with the mold; and based on the comparison indicating a change in state of the mold, trigger a recommended action for the mold.

In some examples, a computer-implemented method includes receiving, by a digital data gatherer from a sensor implemented on a mold, first information associated with the mold, the received first information comprising at least one of measured plastic melt pressure, plastic melt temperature, water line temperature, blow air temperature, exhaust, or unscrewing/ejection force data; generating, by a digital molding process fingerprint generator, a digital molding process fingerprint associated with the mold based on the received first information; storing, in a memory, the generated digital molding process fingerprint; receiving, by the digital data gatherer from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data; comparing, by a digital data analyzer, the received first information to the generated digital molding process fingerprint associated with the mold; and based on the comparison indicating a change in state of the mold, triggering, by an alert generator, a recommended action for the mold.

In some examples, one or more non-transitory computer-readable media store instructions that, when executed by a processor, cause the processor to: receive, from a sensor implemented on a mold, first information associated with the mold, the received first information comprising at least one of measured plastic melt pressure, plastic melt temperature, water line temperature, blow air temperature, exhaust, or unscrewing/ejection force data; generate a digital molding process fingerprint associated with the mold based on the received first information; store, in the memory, the generated digital molding process fingerprint; receive, from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data; determine a degree of difference between the received information and the generated digital molding process fingerprint, the degree of difference indicating a state of the mold; identify at least one aspect of the received second information as contributing to the change in the state of the mold; based on the degree of difference indicating a change in the state of the mold, trigger a recommended action for the mold; and display, on a user interface device, a dashboard that presents at least one of the generated digital molding process fingerprint for the mold, the received second information associated with the mold, and the triggered recommended action for the mold.

Further examples for are described herein.

Various examples further include one or more of the following:
wherein the stored digital molding process fingerprint is associated with one or more of an injection mold machine, injection stretch blow mold machine, injection blow mold machine, or extrusion blow mold machine;
wherein the processor is further configured to: receive, from an image capturing device implemented on the mold, a first image of the mold; and generate the digital molding process fingerprint based at least in part on the received first image of the mold;
wherein the processor is further configured to: receive, from the image capturing device implemented on the mold, a second image of the mold; compare the received second image of the mold to the received first image of the mold; and based on the comparison of the received second image to the received first image indicating a visual change in the mold, trigger a second recommended action for the mold;
wherein: to compare the received first information to the generated digital molding process fingerprint associated with the mold, the processor is further configured to: determine a degree of difference between the received information and the generated digital molding process fingerprint, the degree of difference indicating the state of the mold; and identify at least one aspect of the received second information as contributing to the change in the state of the mold;
wherein the processor is further configured to generate, using an artificial intelligence (AI) model, a time-and condition-based alert for intervention on the mold based on i) the determined degree of difference between the received information and the generated digital molding process fingerprint, and ii) the identified at least one aspect of the received second information as contributing to the change in the state of the mold;
wherein the processor is further configured to: based on the generated time-and condition-based alert indicating a first degree of difference associated with a first state, trigger a first recommended action, wherein the first recommended action for invention is a maintenance action of the mold; and based on the generated time-and condition-based alert indicating a second degree of difference associated with a second state, trigger a second recommended action, wherein the second recommended action for intervention is a replacement of the mold;
further comprising a user interface device configured to: display a dashboard that presents at least one of the generated digital molding process fingerprint for the mold, the received second information associated with the mold, and the triggered recommended action for the mold;
wherein the processor is further configured to: output, to at least one of an external device or a user interface device, an alert indicating the triggered recommended action, data indicating the change in the state of the mold, and the received second information identified as contributing to the change in the state of the mold;
wherein the sensor includes a plurality of sensors, each sensor of the plurality of sensors associated with a different portion of the mold; and
wherein the sensor is an internet of things (IoT) sensor.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system, comprising:
a memory; and
a processor coupled to the memory and configured to:
receive, from a sensor implemented on a mold, first information associated with the mold, the received first information comprising at least one of measured plastic melt pressure, plastic melt temperature, water line temperature, blow air temperature, exhaust, or unscrewing/ejection force data;
generate a digital molding process fingerprint associated with the mold based on the received first information;
store, in the memory, the generated digital molding process fingerprint;
receive, from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data;
compare the received first information to the generated digital molding process fingerprint associated with the mold; and
based on the comparison indicating a change in state of the mold, trigger a recommended action for the mold.

2. The system of claim 1, wherein the stored digital molding process fingerprint is associated with one or more of an injection mold machine, injection stretch blow mold machine, injection blow mold machine, or extrusion blow mold machine.

3. The system of claim 1, wherein the processor is further configured to:
receive, from an image capturing device implemented on the mold, a first image of the mold; and
generate the digital molding process fingerprint based at least in part on the received first image of the mold.

4. The system of claim 3, wherein the processor is further configured to:
receive, from the image capturing device implemented on the mold, a second image of the mold;
compare the received second image of the mold to the received first image of the mold; and
based on the comparison of the received second image to the received first image indicating a visual change in the mold, trigger a second recommended action for the mold.

5. The system of claim 1, wherein:
to compare the received first information to the generated digital molding process fingerprint associated with the mold, the processor is further configured to:
determine a degree of difference between the received information and the generated digital molding process fingerprint, the degree of difference indicating the state of the mold; and
identify at least one aspect of the received second information as contributing to the change in the state of the mold; and
the processor is further configured to generate, using an artificial intelligence (AI) model, a time-and condition-based alert for intervention on the mold based on i) the determined degree of difference between the received information and the generated digital molding process fingerprint, and ii) the identified at least one aspect of the received second information as contributing to the change in the state of the mold.

6. The system of claim 5, wherein the processor is further configured to:
based on the generated time-and condition-based alert indicating a first degree of difference associated with a first state, trigger a first recommended action, wherein the first recommended action for invention is a maintenance action of the mold; and
based on the generated time-and condition-based alert indicating a second degree of difference associated with a second state, trigger a second recommended action, wherein the second recommended action for intervention is a replacement of the mold.

7. The system of claim 1, further comprising a user interface device configured to:
display a dashboard that presents at least one of the generated digital molding process fingerprint for the mold, the received second information associated with the mold, and the triggered recommended action for the mold.

8. The system of claim 1, wherein the processor is further configured to:
output, to at least one of an external device or a user interface device, an alert indicating the triggered recommended action, data indicating the change in the state of the mold, and the received second information identified as contributing to the change in the state of the mold.

9. The system of claim 1, wherein the sensor includes a plurality of sensors, each sensor of the plurality of sensors associated with a different portion of the mold.

10. The system of claim 1, wherein the sensor is an internet of things (IoT) sensor.

11. A computer-implemented method, comprising:
receiving, by a digital data gatherer from a sensor implemented on a mold, first information associated with the mold, the received first information comprising at least one of measured plastic melt pressure, plastic melt temperature, water line temperature, blow air temperature, exhaust, or unscrewing/ejection force data;
generating, by a digital molding process fingerprint generator, a digital molding process fingerprint associated with the mold based on the received first information;
storing, in a memory, the generated digital molding process fingerprint;
receiving, by the digital data gatherer from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data;
comparing, by a digital data analyzer, the received first information to the generated digital molding process fingerprint associated with the mold; and
based on the comparison indicating a change in state of the mold, triggering, by an alert generator, a recommended action for the mold.

12. The computer-implemented method of claim 11, further comprising:
receiving, by the digital data gatherer from an image capturing device implemented on the mold, a first image of the mold;
generating the digital molding process fingerprint based at least in part on the received first image of the mold;
receiving, by the digital data gatherer from the image capturing device implemented on the mold, a second image of the mold;
comparing, by the digital data analyzer, the received second image of the mold to the received first image of the mold; and
based on the comparison of the received second image to the received first image indicating a visual change in the mold, triggering, by the alert generator, a second recommended action for the mold.

13. The computer-implemented method of claim 11, further comprising:
determining a degree of difference between the received information and the generated digital molding process fingerprint, the degree of difference indicating the state of the mold;
identifying at least one aspect of the received second information as contributing to the change in the state of the mold; and
generating, using an artificial intelligence (AI) model, a time-and condition-based alert for intervention on the mold based on i) the determined degree of difference between the received information and the generated digital molding process fingerprint, and ii) the identified at least one aspect of the received second information as contributing to the change in the state of the mold.

14. The computer-implemented method of claim 13, further comprising:
based on the generated time-and condition-based alert indicating a first degree of difference associated with a first state, triggering a first recommended action, wherein the first recommended action for invention is a maintenance action of the mold; and
based on the generated time-and condition-based alert indicating a second degree of difference associated with a second state, triggering a second recommended action, wherein the second recommended action for intervention is a replacement of the mold.

15. The computer-implemented method of claim 11, further comprising:
displaying, on a user interface device, a dashboard that presents at least one of the generated digital molding process fingerprint for the mold, the received second information associated with the mold, and the triggered recommended action for the mold; and
outputting, to the displayed dashboard, an alert indicating the triggered recommended action, data indicating the change in the state of the mold, and the received second information identified as contributing to the change in the state of the mold.

16. One or more non-transitory computer-readable media storing instructions that, when executed by a processor, cause the processor to:
receive, from a sensor implemented on a mold, first information associated with the mold, the received first information comprising at least one of measured plastic melt pressure, plastic melt temperature, water line temperature, blow air temperature, exhaust, or unscrewing/ejection force data;
generate a digital molding process fingerprint associated with the mold based on the received first information;
store, in the memory, the generated digital molding process fingerprint;
receive, from the sensor, second information associated with the mold, the received second information comprising at least one of mold cycle count, mold cycle time, updated measured plastic melt pressure, updated plastic melt temperature, updated water line temperature, updated blow air temperature, updated exhaust, or updated unscrewing/ejection force data;
determine a degree of difference between the received information and the generated digital molding process fingerprint, the degree of difference indicating a state of the mold;
identify at least one aspect of the received second information as contributing to the change in the state of the mold;
based on the degree of difference indicating a change in the state of the mold, trigger a recommended action for the mold; and
display, on a user interface device, a dashboard that presents at least one of the generated digital molding process fingerprint for the mold, the received second information associated with the mold, and the triggered recommended action for the mold.

17. The one or more non-transitory computer-readable media of claim 16, further storing instructions that, when executed by the processor, cause the processor to:
generate, using an artificial intelligence (AI) model, a time-and condition-based alert for intervention on the mold based on i) the determined degree of difference between the received information and the generated digital molding process fingerprint, and ii) the identified at least one aspect of the received second information as contributing to the change in the state of the mold.

18. The one or more non-transitory computer-readable media of claim 17, further storing instructions that, when executed by the processor, cause the processor to:
based on the generated time-and condition-based alert indicating a first degree of difference associated with a first state, trigger a first recommended action, wherein the first recommended action for invention is a maintenance action of the mold; and
based on the generated time-and condition-based alert indicating a second degree of difference associated with a second state, trigger a second recommended action, wherein the second recommended action for intervention is a replacement of the mold.

19. The one or more non-transitory computer-readable media of claim 16, further storing instructions that, when executed by the processor, cause the processor to:
receive, from an image capturing device implemented on the mold, a first image of the mold;
generate the digital molding process fingerprint based at least in part on the received first image of the mold;
receive, from the image capturing device implemented on the mold, a second image of the mold;
compare, the received second image of the mold to the received first image of the mold; and
based on the comparison of the received second image to the received first image indicating a visual change in the mold, trigger a second recommended action for the mold.

20. The one or more non-transitory computer-readable media of claim 16, wherein the stored digital molding process fingerprint is associated with one or more of an injection mold machine. injection stretch blow mold machine, injection blow mold machine, or extrusion blow mold machine.
